(19) United States
(12) Patent Application Publication
(10) Pub. No.: US 2023/0334594 A1
(43) Pub. Date: Oct. 19, 2023

(54) CONTEXT-BASED SETTINGS RECOMMENDATIONS

(71) Applicant: Facebook, Inc., Menlo Park, CA (US)

(72) Inventors: Francesco Fogu, Tiburon, CA (US); Mindi Yuan, Palo Alto, CA (US); Hitomi Dolly Hayashi-Branson, Mountain View, CA (US); Luqian Wang, Cupertino, CA (US); Stanley Brode, Los Angeles, CA (US); Katherine Liu, Los Altos, CA (US); Lauren Wong, San Francisco, CA (US); Himabindu Gadupudi, Milpitas, CA (US); Shuang Liu, Union City, CA (US)

(21) Appl. No.: 17/540,949

(22) Filed: Dec. 2, 2021

(51) Int. Cl. G06Q 50/00

(52) U.S. Cl. CPC G06Q 50/01

(57) ABSTRACT

Techniques for identifying a trigger associated with a recommendation to modify settings associated with a user account of a social networking system, and providing a recommendation to a user to review and/or modify the settings are described herein. The settings may include settings associated with other users commenting on data published by the user via the social networking system (e.g., posts published by the user), tagging or mentioning the user in a post, sending a direct message to the user, and/or the like. That is, the social networking system may be configured to identify a triggering event (e.g., trigger) associated with interactions with the user account, and to provide a recommendation for the user to review and/or modify one or more settings associated with the user account based on the interactions, such as to improve an overall user experience with the social networking system.

### BACKGROUND

Social networking systems provide users with a myriad ways of communicating and sharing information with one another. For instance, a social networking system may enable communications between a user and one or more other users, such as in posts published via a messaging feed, in a story about the user, as a direct message between the user and at least one other user, and/or the like. Often, the social networking system may enable the creator of the post (or other type of communication) and/or another user viewing the post to comment, tag other users, mention other users, and/or otherwise associate other user accounts with the post. In order to provide the user with control over an associated user account, the social networking system may provide a means by which the user can establish one or more settings associated with a user account thereof, such as to control who may view content published by the user, who can comment on posts, tag the user, send messages to the user, and/or the like. However, once an account is initially generated, many users do not think to modify the setting(s), despite changes to the user account, changes occurring in the user's life, or any other changes that may affect interactions with the user account, by the user and others.

Additionally, at times, a user may be subjected to harsh comments and/or bullying via the social networking system. The user may individually delete the harsh and/or bullying comments, such as to remove the harsh and/or bullying comments from publication in association with the user account. However, the individual deletion of each comment may, based on a number of comments, require a significant amount of time and computing resources to identify and select each comment for deletion. The individual deletion may additionally require the user to view each message prior to deletion, thereby emotionally impacting the user and leading to a negative user experience.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to implement context-based settings recommendations, as described herein.

FIGS. 2A and 2B illustrate example interfaces associated with enabling a user access to comment control settings associated with a user account, as described herein.

FIGS. 3A-3E illustrate example interfaces associated with detecting a trigger associated with providing a recommendation for a user to review control settings, as described herein.

FIGS. 4A-4C illustrate example interfaces associated with detecting another trigger associated with providing a recommendation for a user to review control settings, as described herein.

FIGS. 5A-5C illustrate example interfaces associated with yet another trigger associated with providing a recommendation for a user to review control settings, as described herein.

FIGS. 6A and 6B illustrate example interfaces associated with enabling a user access to comment control settings associated with a post, as described herein.

FIGS. 7A-7C illustrate example interfaces associated with detecting an activity based trigger associated with providing a recommendation for a user to review control settings, as described herein.

FIGS. 8A-8E illustrate example interfaces associated with detecting a trigger associated with providing a recommendation for a user to review tag control settings associated with a user account, as described herein.

FIGS. 9A and 9B illustrate example interfaces associated with detecting a trigger associated with providing a recommendation for a user to review message control settings associated with a user account, as described herein.

FIG. 10 illustrates an example interface associated with providing a recommendation for a user to review controls settings associated with a user account, as described herein.

FIG. 11 is an example system for providing users with context-based settings recommendations, as described herein.

FIG. 12 illustrates an example process for providing a recommendation to review or modify one or more settings associated with a user account based on an identified trigger, as described herein.

### DETAILED DESCRIPTION

This application describes techniques for identifying a trigger associated with a recommendation to modify settings associated with a user account of a social networking system, and providing a recommendation to a user to review and/or modify the settings. In at least one example, the settings may include settings associated with other users commenting on data published by the user via the social networking system (e.g., posts published by the user). That is, the social networking system may be configured to identify a triggering event (e.g., trigger) associated with user comments, and to provide a recommendation for the user to review and/or modify one or more settings associated with the comments, such as to improve an overall user experience with the social networking system.

As discussed above, traditionally, users may establish one or more settings associated with a user account at the inception of the user account. Often, users are so eager to initiate communications with others via the social networking system, that they fail to establish user-defined settings, and instead, maintain default settings, which may include standard, open settings to maximize discoverability of the new user and communications with other users of the social networking system. However, the default settings may not always account for changes to a user account, such as increased activity and engagement by other users with the user account. Despite this, once an account is initially generated, many users do not think to modify the setting(s). As such, many users may become overwhelmed with the increased activity, which may lead to a negative user experience.

In some examples, the increased activity and/or engagement with the user account may include an increase in negative activity, such as harsh and/or bullying comments by other users directed to the user associated with the user account. Conventional systems enable the user to individually delete the harsh and/or bullying comments, such as to remove the harsh and/or bullying comments from publication in association with the user account. However, the individual deletion of each comment may require a significant amount of time and computing resources to identify and select each comment for deletion. Additionally, the individual deletion may require the user to view each message prior to deletion, thereby emotionally impacting the user and leading to a negative user experience.

The techniques described herein including providing a recommendation to a user to review or modify (e.g., update) settings associated with a user account of the user. As non-limiting examples, the settings may include settings associated with other users commenting on data published by the user via the social networking system (e.g., posts published by the user), tagging, mentioning, or otherwise associating the user with a post generated by another user, sending a direct message to the user, and/or the like. That is, the settings can include interactions by other users with the user, the user account, and data published in association therewith. In various examples, the social networking system may provide a user interface element on a user interface of a social networking application, that, when selected by the user, enables the user to modify one or more settings associated with the user account. That is, in some examples, the social networking system may provide a permanently accessible affordance configured to enable the user to access and/or modify the setting(s) associated with the user account.

Additionally, in at least one example, the social networking system may be configured to provide a recommendation to the user to review and/or modify the setting(s) associated with the user account. In some examples, the social networking system may cause the recommendation to be presented in association with a notification, such as a pop-up notification or other notification associated with the user interface of the social networking application. In at least one example, the social networking system may provide the recommendation in response to identifying a trigger (e.g., triggering action) associated with the user account.

In some examples, the trigger may be associated with an interaction of the user with the user account. Non-limiting examples of interactions of the user with the user account include generating and publishing a post, message, and/or other communication in association with the user account, accessing a settings page associated with the user account, a deletion of one or more comments associated with a post, blocking another user account from a post and/or from accessing data associated with the user account, an indication of intent to delete a comment or perform another action with respect to an interaction by another user with the user account, disabling a commenting functionality with respect to one or more posts, viewing activity corresponding to interactions of other users with the user account (comments, tags, mentions, etc.), viewing a message generated by another user with whom the user is not connected, and/or other interactions of the user with the user account.

In some examples, the trigger may be associated with an interaction of other users with the user account. Non-limiting examples of interactions of the other users with the user account include transmitting a comment, reaction, emoji, GIF, video, image, or the like in response to a post published (by the first user 102(1)) in association with the user account, transmitting a direct message to the first user 102(1) via the user account, transmitting a request to connect with the first user 102(1) and/or the user account (e.g., become a follower, friend, contact, etc.), tagging or mentioning the first user 102(1) associated with the user account in a post or communication published via the social networking system 106, and/or other interactions with the user account of the first user 102(1).

In various examples, the trigger may be associated with a number of connections (e.g., contacts, followers, friends, etc.) associated with a user account has exceeded a threshold number (e.g., 1,000, 10,000, etc.). That is, the social networking system may identify a trigger based a total number of other users who are connected to or follow the user account. In some examples, the trigger may be associated with a total number of comments, published by other users, that are associated with one or more posts published by the user in association with the user account. In some examples, the total number of comments may include comments associated with a particular post and/or comments that are received in association with one or more posts over a period of time (e.g., 24 hours, 1 week, etc.). For example, the social networking system may identify the trigger in response to determining that a number of comments received in association with a post published in association with the user account exceeds a threshold number for a period of time. In some examples, the trigger may be associated with a frequency of comments received over a period of time. That is, the social networking system may identify that a spike in a frequency of comments exceeds a threshold frequency, and may identify the trigger based on the increased frequency of interactions by other users with the user account.

In some examples, the trigger may be associated with anticipated (future) interactions (e.g., increased activity) with users based on a participation of the user in an event. The interactions may include anticipated connection requests (e.g., requests to follow the user account), direct messages, comments on posts published by the user, and/or the like. That is, the anticipated interactions can include an anticipated desire by other users to connect or communicate with the user associated with the user account based on a participation in the event. The event may include an event type that may impact a level of fame, publicity, and/or attention received by the user associated with the user account. Non-limiting examples of the event include a televised sporting event, appearance or association with a television show, movie, or advertisement, acceptance (e.g., drafting) onto a professional sporting team, release of an album (e.g., for a musician, singer, etc.), and/or other activity that may result in increased interactions by others with the user account. In various examples, the social networking system may be configured to determine a probability of increased activity or interactions by other users with the user account in response to a participation (or anticipated participation), by the user, in the event. The probability of increased activity may be determined utilizing historical data associated with similar events and identified interactions with user accounts of participants of the similar events, an analysis of activity across the social networking system during a period of time associated with the event (e.g., how much traction or activity is associated with the event on the social networking system, etc.), and/or the like. In various examples, the social networking system may be configured to identify the probability of increased activity utilizing machine learning techniques, statistical analysis, or another technique for identifying a probability of increased activity on, and/or interactions, with a user account.

In response to identifying the trigger, the social networking system may generate a notification for presentation in association with the user account. The notification may be presented to the user, such as via a user interface of a social networking application, during user interaction with the user account. The notification may include a pop-up notification, an overlay on the user interface, a highlight or headline associated with the user interface, or other means by which social networking system may draw attention to information provided in the notification.

In various examples, the notification may include a recommendation to review or modify one or more settings associated with the user account. As discussed above, the settings may include settings associated with other users commenting on data published by the user via the social networking system (e.g., posts published by the user), tagging, mentioning, or otherwise associating the user with a post generated by another user, sending a direct message to the user, and/or the like. In various examples, the recommendation may include a recommendation to modify a particular setting, such as based on the trigger and/or identified interactions with the user account. In some examples, the recommendation may include a recommendation to review settings associated with a particular post and/or the user account, such as to provide the user with a reminder or prompt to review the settings in order to verify that the settings are appropriate for current conditions and/or interactions with the user account.

In various examples, a process may include identifying one or more interactions of one or more users of a social networking system with a user account of the social networking system. The process may further include identifying, based at least in part on the one or more interactions, a trigger associated with a recommendation to review or modify a setting associated with the user account, wherein the setting relates to an ability of other user accounts to interact with the user account, and in response to identifying the trigger, causing a notification to be presented on a user interface of a user computing device associated with the user account, the notification comprising the recommendation to review or modify the setting associated with the user account.

In some examples, the process may further include receiving, from the user computing device via the user interface, a first indication of selection of a selectable control associated with the notification, and in response to receiving the first indication of selection, causing a presentation, in association with the user interface, of a menu including one or more settings associated with the user account that are configured to be modified via the menu. The process may further include receiving, from the user computing device and in association with the menu, a request to modify at least one setting of the one or more settings; and updating the at least one setting based at least in part on the request, wherein updating the at least one setting comprises disabling or enabling a permission of another user to interact with the user account.

In some examples, the process may further include determining at least one of a number of interactions or a frequency of interactions with the user account over a period of time, wherein the trigger comprises a determination that the at least one of the number of interactions or the frequency of interactions meets or exceeds a threshold value.

In some examples, the process may further include determining, based at least in part on a context of an interaction of the one or more interactions, that a user associated with the user account is associated with an event. The process may yet further include determining that a probability of increased interactions with the user account from a plurality of users of the social networking system based on a participation of the user in the event exceeds a threshold probability. The process may still yet further include determining that a current time is within a threshold period of time of a time associated with the event, wherein identifying the trigger comprises identifying that the event in which the probability of increased interactions meets or exceeds a threshold is within the threshold period of time of the current time, and wherein the notification comprises a first recommendation to modify the setting associated with the user account to a more restrictive setting.

In some examples, the trigger may be a first trigger occurring at the first time and the process may further include identifying an end time associated with the event; determining, at a second time after the first time, that a second threshold period of time has passed since the end time, the second threshold period of time being associated with a cool down period after the event. The process may yet further include identifying a second trigger associated with the recommendation to review or modify the setting associated with the user account, and in response to identifying the second trigger, causing a second notification to be presented in association with the user account, the second notification comprising a second recommendation to modify the setting to a less restrictive setting.

In some examples, the process may further include identifying that a first interaction of the one or more interactions by a user associated with the user account comprises an indication of selection of a comment, by a second user associated with a second user account, and presented in association with a post generated by the user and published via the social networking system, a selection of the comment being associated with viewing one or more actions associated with the comment. The process may still further include causing a presentation, on the user interface of the user computing device, of one or more indicators associated with the one or more actions, and receiving an indication of selection of a cancel selectable control associated with not performing an action of the one or more actions, wherein the trigger comprises a determination that the user did not perform the action associated with the comment.

In some examples, the process may further include identifying that a first interaction of the one or more interactions by a user associated with the user account comprises a request to delete a comment published by a second user associated with a second user account and presented in association with a post generated by the user and presented via the user interface, and in response to the request to delete the comment, withholding data associated with the comment from presentation via the user interface, wherein the trigger comprises a determination that the user deleted the comment associated with the post, and wherein the recommendation comprises a recommended action to review comment settings associated with at least one of the post or the user account.

In some examples, the setting may include at least one of: a comment control; a tag control; a messaging control; or a mention control.

In various examples, a system may include one or more processors and one or more non-transitory computer-readable media storing instructions that, when executed by the one or more processors, cause the system to perform operations including identifying one or more interactions of one or more users of a social networking system with a user account of the social networking system. The operations may further include identifying, based at least in part on the one or more interactions, a trigger associated with a recommendation to review or modify a setting associated with the user account, wherein the setting relates to an ability of other user accounts to interact with the user account. In response to identifying the trigger, the operations may further include causing a notification to be presented on a user interface of a user computing device associated with the user account, the notification comprising the recommendation to review or modify the setting associated with the user account.

In various examples, identifying the trigger may include determining that a value associated with a characteristic of the user account meets or exceeds a threshold value. In some examples, the characteristic may include at least one of: a number of other user accounts that are associated with the user account; a frequency of interactions of the other user accounts that are associated with the user account; or a number of comments received from the other user accounts in association with a communication published in association with the user account.

In some examples, identifying the trigger may further include identifying a communication published by a first user corresponding to the user account, and identifying an interaction of the one or more interactions associated with the user in association with a comment published by a second user in response to the communication, wherein the interaction comprises at least one of: a request to delete the comment; or an indication of intent to perform an action associated with the comment, the action comprising at least one of submitting a report associated with the comment, deleting the comment, restricting comments from the second user in association with the communication, or blocking the second user from accessing the user account.

In some examples, the system may further be configured to perform operations including receiving, from the user computing device via the user interface, a first indication of selection of a selectable control associated with the notification. In some examples, the system may further be configured to, in response to receiving the first indication of selection, cause a presentation, in association with the user interface, of a menu associated with one or more settings associated with the user account that are configured to be modified via the menu. In some examples, the system may further be configured to receive, from the user computing device and in association with the menu, a request to modify at least one setting of the one or more settings, and update the at least one setting based at least in part on the request.

In some examples, updating the at least one setting comprises disabling or enabling a permission of another user to interact with the user account.

In some examples, wherein identifying the trigger includes determining that a user associated with the user account is associated with an event, and determining that a probability of increased interactions by a plurality of users with the user account, based on a participation of the user in the event, exceeds a threshold probability, wherein the notification comprises a first recommendation to modify the setting associated with the user account to a more restrictive setting.

In various examples, a non-transitory computer-readable media may be configured to identify one or more interactions of one or more users of a social networking system with a user account of the social networking system. The non-transitory computer-readable media may further be configured to identify, based at least in part on the one or more interactions, a trigger associated with a recommendation to review or modify a setting associated with the user account, wherein the setting relates to an ability of other user accounts to interact with the user account, and in response to identifying the trigger, causing a notification to be presented on a user interface of a user computing device associated with the user account, the notification comprising the recommendation to review or modify the setting associated with the user account.

In some examples, the non-transitory computer-readable media may further be configured to receive, from the user computing device via the user interface, a first indication of selection of a selectable control associated with the notification. In some examples, in response to receiving the first indication of selection, the non-transitory computer-readable media may yet further be configured to cause a presentation, in association with the user interface, of a menu associated with one or more settings associated with the user account that are configured to be modified via the menu; receiving, from the user computing device and in association with the menu, a request to modify at least one setting of the one or more settings. In some examples, the non-transitory computer-readable media may still yet further be configured to update the at least one setting based at least in part on the request, wherein updating the at least one setting comprises disabling or enabling an ability of another user to interact with the user account.

As stated above, the non-transitory computer-readable media may be configured to identify the trigger, which may include determining that a value associated with a characteristic of the user account meets or exceeds a threshold value, the characteristic comprising at least one of: a number of other user accounts that are associated with the user account; a frequency of interactions of the other user accounts that are associated with the user account; or a number of comments received from the other user accounts in association with a communication published in association with the user account. In some examples, the setting may include at least one of a comment control; a tag control; a messaging control; or a mention control.

In some examples, the trigger identified by the non-transitory computer-readable media may be identified utilizing machine learning techniques.

Techniques described herein include providing a prompt or reminder (e.g., recommendation) to a user to review and/or modify a setting of a user account based real-time or near-real time conditions or interactions with the user account. The recommendations based on current, actual activity with a user account, may greatly enhance a user experience with regard to the social networking system, and may, in cases of being a target of bullying or abusive behavior, protect a user from undesirable interactions. As such, the real-time recommendations to adjust settings based on current conditions described herein may improve the social networking system overall, at least by providing improving safety and security associated with a user account.

Additionally, as described above, conventional systems enable the user to individually delete select comments, such as to remove the harsh and/or bullying comments from publication in association with the user account. However, the individual deletion of each comment may require a significant amount of time and computing resources to identify and select each comment for deletion. Unlike the conventional systems, the techniques described herein provide a single access point to enable the user to modify settings associated with the user account and/or a particular post that is receiving a lot of attention. The single access point to modify settings, may decrease an amount of time and/or processing power associated with removing or preventing unwanted interactions with the user account. For example, the user may utilize the single access point to modify settings associated with a particular post or with respect to one or more users, thereby quickly and efficiently updating the user account. Accordingly, the techniques described herein may reduce an amount of time and computing resources required to prevent or limit undesirable interactions with a user account, thereby improving the functioning of a user computing device and decreasing a total amount of network bandwidth needed to prevent or limit the undesirable interactions (e.g., processing a single request to modify settings in lieu of processing multiple individual deletion requests, etc.).

These and other aspects are described further below with reference to the accompanying drawings. The drawings are merely an example implementation and should not be construed to limit the scope of the claims. For example, while examples are illustrated in the context of a user interface for a mobile device, the techniques may be implemented using any computing device and the user interface may be adapted to the size, shape, and configuration of the particular computing device.

### Example System Architecture

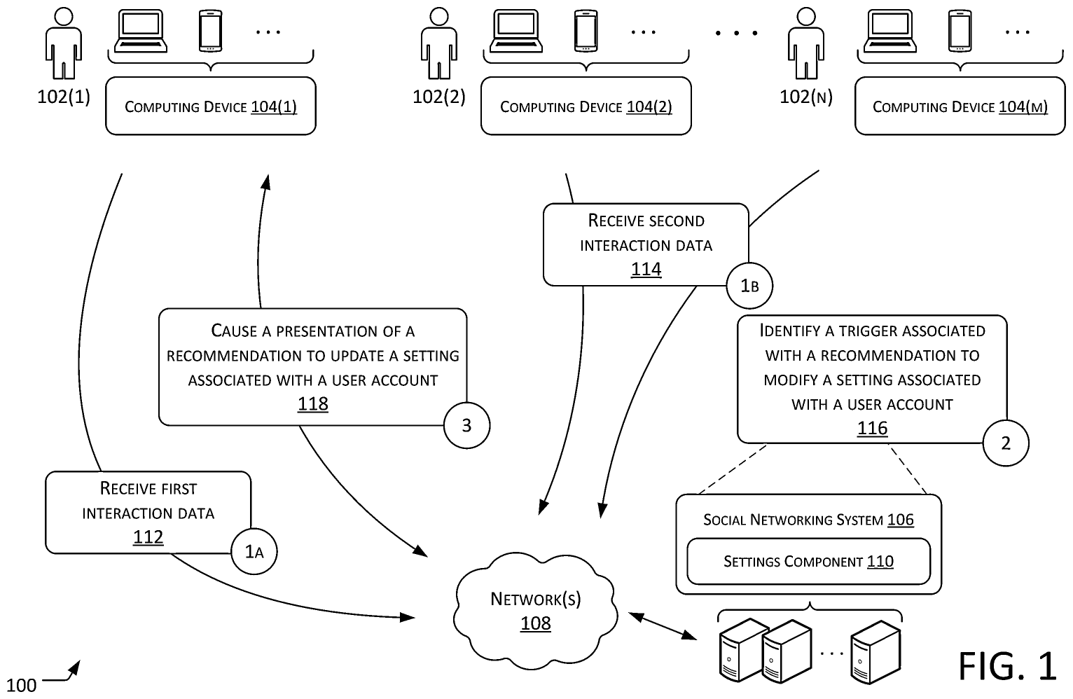

FIG. 1 is a schematic view of an example computing system 100 (“system 100”) usable to implement example techniques described herein to facilitate updating a user account based on real-time conditions associated with the user account (e.g., user interactions with the user account). In some examples, the system 100 may include users 102(1), 102(2), . . . 102(n) (collectively “users 102”) to interact using computing devices 104(1), 104(2), . . . 104(m) (collectively “computing devices 104”) with a social networking system 106 via a network 108. In this example, n and m are non-zero integers greater than 1.

Each of the computing devices 104 includes one or more processors and memory storing computer executable instructions to implement the functionality discussed herein attributable to the various computing devices. In some examples, the computing devices 104 may include desktop computers, laptop computers, tablet computers, mobile devices (e.g., smart phones or other cellular or mobile phones, mobile gaming devices, portable media devices, etc.), or other suitable computing devices. The computing devices 104 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 104 may access the social networking system 106 and/or communicate with one another.

The social networking system 106 may include one or more servers or other computing devices, any or all of which may include one or more processors and memory storing computer executable instructions to implement the functionality discussed herein attributable to the social networking system or digital platform. The social networking system 106 may enable its users 102 (such as persons or organizations) to interact with the social networking system 106 and with each other via the computing devices 104. The social networking system 106 may, with input from a user, create and store in the social networking system 106 a user account associated with the user. The user account may include demographic information, communication-channel information, financial information, information on personal interests of the user, as well as other user information (e.g., real name, username, handle, contact information, etc.). The social networking system 106 may also, with input from a user, create and store a record of relationships (e.g., connections, followers, friends, contacts, etc.) of the user with other users of the social networking system, as well as provide services (e.g., posts, comments, photo-sharing, messaging, tagging, mentioning of other users or entities, games, shopping, etc.) to facilitate social interaction between or among the users 102.

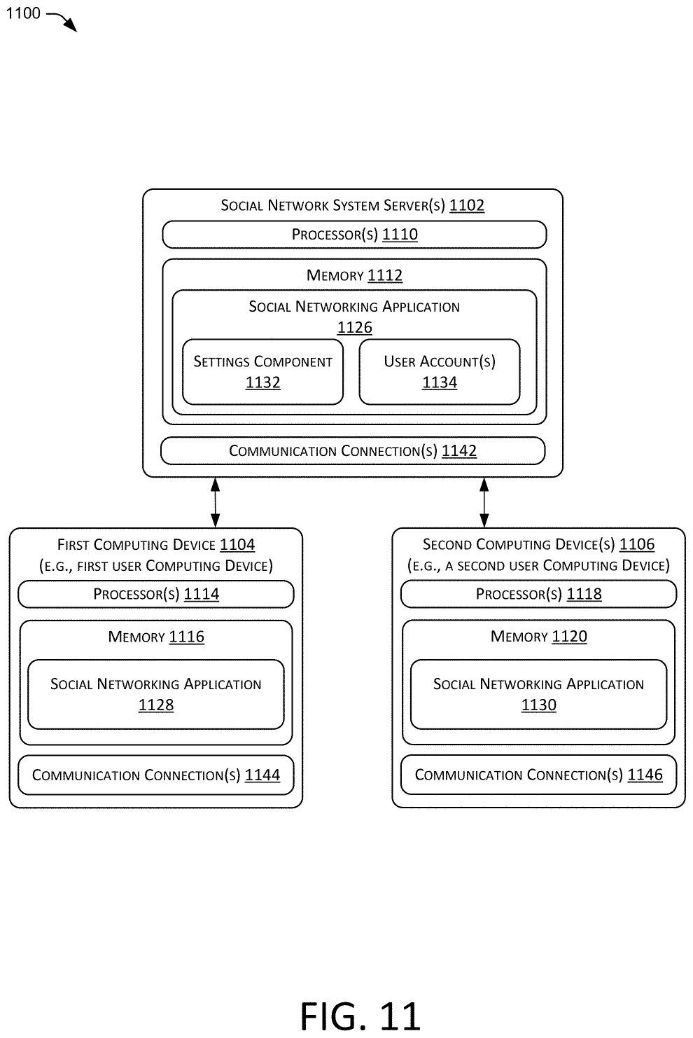

In some examples, the social networking system 106 (and similarly, the system 1100 described in relation to FIG. 11 below) may provide privacy features to the users 102 while interacting with the social networking system 106. In particular examples, one or more objects (e.g., content, registries, or other types of objects) of the computing system 100 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” and/or a “restricted list” of users or other entities that should not be allowed to access certain information associated with the object. In particular examples, the blocked list may include third-party entities. The blocked list or restricted list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a user 102(1) may share an object (e.g., a post, a message and/or a communication including text, an image, a video, an emoji, a GIF, etc.) to the social networking system 106. The object may be associated with a concept node connected to a user node of the user 102(1) by an edge. The user 102(1) may specify privacy settings that apply to a particular edge connecting to the concept node of the object, or may specify privacy settings that apply to all edges connecting to the concept node. In some examples, the user 102(1) may share a set of objects of a particular object-type (e.g., posts). The user 102(1) may specify privacy settings with respect to all objects associated with the user 102(1) of that particular object-type as having a particular privacy setting (e.g., specifying that all posts published by the user 102(1) are visible only to friends of the user and/or users tagged in the images).

In particular examples, the social networking system 106 may present a “privacy wizard” (e.g., within a webpage, a module, one or more dialog boxes, or any other suitable interface) to the user 102(1) to assist the user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the social networking system 106 may offer a “dashboard” functionality to the user 102(1) that may display, to the user 102(1), current privacy settings of the user 102(1). The dashboard functionality may be displayed to the user 102(1) at any appropriate time (e.g., following an input from the user 102(1) summoning the dashboard functionality, following the occurrence of a particular event or trigger action). The dashboard functionality may allow the user 102(1) to modify one or more of the user's current privacy settings at any time, in any suitable manner (e.g., redirecting the user 102(1) to the privacy wizard).

Privacy settings associated with an object (e.g., a post, message, etc.) may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers of the social networking system 106 may be authorization/privacy servers for enforcing privacy settings. In response to a request from the user 102(1) (or other entity) for a particular object stored in a data store, the social networking system 106 may send a request to the data store for the object. The request may identify the user 102(1) associated with the request and the object may be sent only to the user 102(1) (or a client system of the user) if the authorization server determines that the user 102(1) is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular examples, an object may represent content that is visible to a user through a newsfeed of the user. As an example and not by way of limitation, one or more objects may be visible to a user's “Trending” page. In particular examples, an object may correspond to a particular user. The object may be content associated with the particular user, or may be the particular user's account or information stored on the social networking system 106, or other computing system. As an example and not by way of limitation, the user 102(1) may view one or more other users 102(2) . . . 102(N) of an online social network through a “People You May Know” function of the online social network, or by viewing a list of friends of the user 102(1). As an example and not by way of limitation, the user 102(1) may specify that they do not wish to see objects associated with a particular other user (e.g., the user 102(2)) in their newsfeed or friends list. If the privacy settings for the object do not allow it to be surfaced to, discovered by, or visible to the user 102(1), the object may be excluded from the search results. Although this disclosure describes enforcing privacy settings in a particular manner, this disclosure contemplates enforcing privacy settings in any suitable manner.

In particular examples, different objects of the same type associated with a user may have different privacy settings. Different types of objects associated with a user may also have different types of privacy settings. As an example and not by way of limitation, the user 102(1) may specify that the user's status updates are public, but objects (e.g., posts, messages, etc.) shared by the user are visible only to the user's friends on the online social network. In some examples, the user 102(1) may specify different privacy settings for different types of entities, such as individual users, friends-of-friends, followers, user groups, or corporate entities. In some examples, the user 102(1) may specify a group of users that may view videos posted by the user 102(1), while keeping the videos from being visible to the user's employer. In particular examples, different privacy settings may be provided for different user groups or user demographics. As an example and not by way of limitation, the user 102(1) may specify that other users who attend the same university as the user 102(1) may view the user's pictures, but that other users who are family members of the user 102(1) may not view those same pictures.

In particular examples, the social networking system 106 may provide one or more default privacy settings for each object of a particular object-type. A privacy setting for an object that is set to a default may be changed by a user associated with that object. As an example and not by way of limitation, all registries posted by the user 102(1) may have a default privacy setting of being visible only to friends of the first user and, for a particular post, message, or other communication, the user 102(1) may change the privacy setting for the post, message, or other communication to be visible to friends and friends-of-friends.

In particular examples, privacy settings may allow the user 102(1) to specify (e.g., by opting out, by not opting in) whether the social networking system 106 may receive, collect, log, or store particular objects or information associated with the user 102(1) for any purpose. In particular examples, privacy settings may allow the user 102(1) to specify whether particular applications or processes may access, store, or use particular objects or information associated with the user. The privacy settings may allow the user 102(1) to opt in or opt out of having objects or information accessed, stored, or used by specific applications or processes. The social networking system 106 may access such information in order to provide a particular function or service to the user 102(1), without the social networking system 106 having access to that information for any other purposes. Before accessing, storing, or using such objects or information, the social networking system 106 may prompt the user 102(1) to provide privacy settings specifying which applications or processes, if any, may access, store, or use the object or information prior to allowing any such action. As an example and not by way of limitation, the user 102(1) may transmit a message to the user 102(2) via an application related to the online social network (e.g., a messaging app), and may specify privacy settings that such messages should not be stored by the social networking system 106.

In particular examples, the user 102(1) may specify whether particular types of objects or information associated with the user 102(1) may be accessed, stored, or used by the social networking system 106. As an example and not by way of limitation, the user 102(1) may specify that images sent by the user 102(1) through the social networking system 106 may not be stored by the social networking system 106. In some examples, the user 102(1) may specify that messages sent from the user 102(1) to another user 102(2) may not be stored by the social networking system 106. In some cases, the user 102(1) may specify that all objects sent via a particular application may be saved by the social networking system 106.

In particular examples, privacy settings may allow the user 102(1) to specify whether particular objects or information associated with the user 102(1) may be accessed from particular client systems or third-party systems. The privacy settings may allow the user 102(1) to opt in or opt out of having objects or information accessed from a particular device (e.g., the phone book on a user's smart phone), from a particular application (e.g., a messaging app), or from a particular system (e.g., an email server). The social networking system 106 may provide default privacy settings with respect to each device, system, or application, and/or the user 102(1) may be prompted to specify a particular privacy setting for each context. As an example and not by way of limitation, the user 102(1) may utilize a location-services feature of the social networking system 106 to provide recommendations for restaurants or other places in proximity to the user 102(1). The default privacy settings of the user 102(1) may specify that the social networking system 106 may use location information provided from the computing device 104(1) of the user 102(1) to provide the location-based services, but that the social networking system 106 may not store the location information of the user 102(1) or provide it to any third-party system. The user 102(1) may then update the privacy settings to allow location information to be used by a third-party image-sharing application in order to geo-tag photos.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular object uploaded by the user is visible to the user's friends for the next week, after which time the object may no longer be accessible to other users.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of a user associated with the objects or information, and may subsequently delete the objects or information, as specified by the respective privacy settings. As an example and not by way of limitation, the user 102(1) may transmit an object to the user 102(2), and the social networking system 106 may temporarily store the message in a data store until the user 102(2) has viewed or downloaded the message, at which point the social networking system 106 may delete the message including the object from the data store. In some examples, continuing with the prior example, the message including the object may be stored for a specified period of time (e.g., 2 weeks), after which point the social networking system 106 may delete the message including the object from the data store.

In particular examples, changes to privacy settings may take effect retroactively, affecting the visibility of objects and content shared prior to the change. As an example and not by way of limitation, the user 102(1) may share a first image and specify that the first image is to be public to all other users. At a later time, the user 102(1) may specify that any images shared by the user 102(1) should be made visible only to a first user group. The social networking system 106 may determine that this privacy setting also applies to the first image and make the first image visible only to the first user group. In particular examples, the change in privacy settings may take effect only going forward. Continuing the example above, if the user 102(1) changes privacy settings and then shares a second image, the second image may be visible only to the first user group, but the first image may remain visible to all users. In particular examples, in response to a user action to change a privacy setting, the social networking system 106 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the social networking system 106 may determine that user 102(1) may want to change one or more privacy settings in response to a trigger (e.g., triggering action) associated with the user 102(1). The trigger may be any suitable action on the online social network. As an example and not by way of limitation, a trigger may be a change in the relationship between a first and second user of the online social network (e.g., “un-friending” a user, changing the relationship status between the users, etc.). In particular examples, upon determining that a trigger has occurred, the social networking system 106 may prompt the user 102(1) to change the privacy settings regarding the visibility of objects associated with the user 102(1). As described here, the prompt or recommendation may redirect the user 102(1) to a workflow process for editing privacy settings with respect to one or more entities associated with the trigger action. The privacy settings associated with the user 102(1) may be changed only in response to an explicit input from the user 102(1), and may not be changed without the approval of the user 102(1). As an example and not by way of limitation, the workflow process may include providing the user 102(1) with the current privacy settings with respect to the user 102(2) or to a group of users (e.g., un-tagging the user 102(1) or the user 102(2) from particular objects, changing the visibility of particular objects with respect to the user 102(2) or a group of users), and receiving an indication from the user 102(1) to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social networking system 106 may determine that such action may be sensitive and may prompt the user to confirm that his or her relationship status should remain public before proceeding. In some examples, a user's privacy settings may specify that the user's posts are visible only to friends of the user. However, if the user changes the privacy setting for his or her posts to being public, the social networking system 106 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the social networking system 106 may send a reminder to the user to confirm his or her privacy settings every six months or after every ten photo posts. In particular examples, privacy settings may also allow users to control access to the objects or information on a per-request basis. As an example and not by way of limitation, the social networking system 106 may notify the user whenever a third-party system attempts to access information associated with the user, and require the user to provide verification that access should be allowed before proceeding.

As briefly described above, the social networking system 106 may be configured to provide a recommendation to a first user 102(1) to review or modify settings associated with a user account of the user 102(1) in response to identifying a trigger (e.g., trigger action) associated with the user account. For instance, the social networking system 106 may identify interactions of the first user 102(1) and/or one or more other users 102(2)-102(n) with a user account of the first user 102(1). A settings component 110 of the social networking system 106 may identify a trigger based at least in part on the interactions. In response to identifying the trigger, the settings component 110 may cause a presentation, on a first computing device of the first user 102(1), of a recommendation to review or modify one or more settings associated with the user account.

For example, at operation 112 (indicated by “1A”), the settings component 110 receives, in association with a user account of a first user 102(1) and from a first computing device 104(1), a first interaction data associated with the user account. The first interaction data may include one or more interactions of the first user 102(1) with the user account and/or with the social networking system 106 in association with the user account. Non-limiting examples of first interaction data include data associated with generating and publishing a post, message, or other communication in association with user account, accessing a settings page associated with the user account, deleting one or more comments associated with a post, blocking another user account from a post and/or from accessing data associated with the user account, providing an indication of intent to delete a comment or perform another action with respect to an interaction by another user with the user account, disabling a commenting functionality with respect to one or more posts, viewing activity corresponding to interactions of other users with the user account (comments, tags, mentions, etc.), viewing a message generated by another user with whom the user is not connected, and/or other interactions of the first user 102(1) with the user account.

At operation 114 (indicated by “1B”), the settings component 110 additionally or alternatively receives second interaction data, in association with the user account of the first user 102(1) and from one or more other computing devices 104 (e.g., computing device 104(2), 104(m), etc.) associated with one or more other users 102 (e.g., user 102(2), 102(n), etc.). The second interaction data may include one or more interactions of the one or more other users 102 with the user account. Non-limiting examples of the second interaction data include transmitting a comment, reaction, emoji, GIF, video, image, or the like in response to a post published (by the first user 102(1)) in association with the user account, transmitting a direct message to the first user 102(1) via the user account, transmitting a request to connect with the first user 102(1) and/or the user account (e.g., become a follower, friend, contact, etc.), tagging or mentioning the first user 102(1) associated with the user account in a post or communication published via the social networking system 106, and/or other interactions with the user account of the first user 102(1).

At operation 116 (indicated by “2”), the settings component 110 of the social networking system 106 may identify a trigger associated with a recommendation to modify a setting associated with the user account. In at least one example, the trigger may be identified based on at least one of the first interaction data or the second interaction data. That is, the trigger may be associated with interactions, by the first user 102(1), with the user account, and/or interactions, by other users 102(2)-102(n), with the user account. For example, a first trigger may include a deletion, by the first user 102(1), of a comment posted by a second user 102(2) in response to a post or communication published by the first user 102(1) and a second trigger may include a second user 102(2) associated with a second user account with whom the first user 102(1) is not connected via the social networking system 106, sending, to the first user 102(1) associated with the user account, a direct message (e.g., private communication between the second user 102(2) and the first user 102(1)).

In various examples, the settings component 110 may identify the trigger based on a number or frequency of interactions associated with the second interaction data. In some examples, the trigger may be identified based on a total number of connections (e.g., contacts, followers, friends, etc.) associated with a user account has exceeded a threshold number (e.g., 2,000, 13,000, etc.) (e.g., threshold value). That is, the social networking system 106 may identify a trigger based a total number of other users 102(2)-102(n) who are connected to or follow the user account of the first user 102(1). For example, the social networking system 106 may receive, from an nth user account associated with an nth user 102(n) with whom the first user 102(1) is not connected via the social networking system 106, a request to connect user accounts (e.g., request to follow, friend request, contact request, etc.). The social networking system 106 may provide, to the first user 102(1) via the user account, an option to accept or deny the request to connect. In response to receiving an indication of acceptance of the request to connect, the social networking system 106 may connect the nth user account with the user account of the first user 102(1) on the social networking system 106. Based on a determination that the connection between the nth user account with the user account of the first user 102(1) causes a total number of connections associated with the user account to meet or exceed a threshold number, the settings component 110 may identify the trigger associated with the recommendation to modify a setting associated with the user account.

In some examples, the trigger may be identified based on a total number of comments, reactions, emojis, and/or the like associated with one or more posts published by the first user 102(1) in association with the user account. In such examples, the settings component 110 may identify the trigger based on a determination that the total number of comments meets or exceeds a threshold number of comments, reactions, emojis and/or the like. In at least one example, the trigger may include a number of comments, reactions, emojis, and/or the like to a particular post published by the first user 102(1). In such an example, the settings component 110 identifies that the number of comments reactions, emojis, and/or the like associated with the particular post meets or exceeds a threshold number.

In some examples, the trigger may be identified based on a number and/or frequency of comments associated with one or more posts corresponding to the user account that are identified, by the settings component 110 or other component of the social networking system 106, as including bullying content (e.g., content that is aggressive, mean, negative, harmful, etc.). In such examples, the settings component 110 (or the other component of the social networking system 106) may be configured to identify bullying content, such as by utilizing machine learning techniques, natural language processing, word (e.g., full words, acronyms, etc.) identification and/or classification, and/or the like. In at least one example, one or more machine learned models may be trained, utilizing training data comprising bullying content, to identify bullying content posted via the social networking system 106. In some examples, in response to identifying the bullying content associated with one or more comments to one or more posts associated with the user account, the settings component 110 may identify the trigger. In some examples, the settings component 110 may identify the trigger based on a determination that a number of comments and/or posts including the bullying content exceeds a threshold amount (e.g., value). In some examples, the threshold amount may include a pre-determined amount. In some examples, the threshold amount may be determined based on historical data associated with interactions associated with the user. In such examples, the threshold may be associated with an increase in the amount of bullying content that is targeted at the first user 102(1) and/or published in association with the user account. For example, the first user 102(1) may be a controversial figure who receives a first amount of negative comments on a regular basis (e.g., determined based on historical data). The settings component 110 may determine that a second amount of negative comments posted in association with the user account over a time period (e.g., 24 hours, 1 week, etc.) exceeds the first amount by the threshold amount (e.g., 120% of the first amount, 150% of the first amount). Based on the determination that second amount exceeds the first amount by the threshold amount, the settings component 110 may identify the trigger.

In some examples, the settings component 110 may identify the trigger based on a frequency of interactions, by one or more other users 102(2)-102(n) with the user account. In some examples, the settings component 110 may identify that the frequency of interactions meets or exceeds a threshold frequency (e.g., 10 comments per hour, 100 comments per day, 25 connect requests per day, etc.). Based on the frequency of interactions meeting or exceeding the threshold frequency, the settings component 110 may identify the trigger associated with the recommendation to modify the setting associated with the user account.

Additionally, in some examples, the settings component 110 may identify the trigger based on an association of the first user 102(1) with an event. In such examples, the trigger may be associated with anticipated (future) interactions (e.g., increased activity) of the other users 102(2)-102(n) with the user account based on the event. Non-limiting examples of the anticipated interactions may include anticipated connection requests (e.g., requests to follow the user account), direct messages, comments on posts published by the user, and/or the like. That is, the anticipated interactions can include an anticipated desire by other users to connect or communicate with the first user 102(1) associated with the user account based on a participation in the event. The event may include an event type that may impact a level of fame, publicity, and/or attention received by the user associated with the user account. Non-limiting examples of the event include a televised sporting event, appearance or association with a television show, movie, or advertisement, acceptance (e.g., drafting) onto a professional sporting team, release of an album (e.g., for a musician, singer, etc.), and/or other activity that may result in increased interactions by the other users 102(2)-102(n) with the user account.

In some examples, the settings component 110 may be configured to identify a participation (e.g., current and/or anticipated future participation), of the first user 102(1), in the event based on a tag (e.g., hashtag, flag, etc.) or other affiliation of the user account with the event. In such examples, the settings component 110 may identify the participation based on explicit input by a user 102 and/or an individual associated with the social networking system 106 (e.g., employee) indicating a participation of the first user 102(1) in the event. For example, an employee of the social networking system 106 may input participation information associated with one or more athletes identified to compete in the Olympics, the one or more athletes including the first user 102(1). Based on the input, the settings component 110 may identify the participation, by the first user 102(1), in the Olympics, and may associate the user account with the participation therein.

In various examples, the settings component 110 may be configured to identify the participation of the first user 102(1) in the event based on user data stored in association with the user account. In some examples, the user data may include an association or affiliation with a team (e.g., team member, etc.), a profession (e.g., musician, athlete, etc.), a hobby or interest, and/or the like. In such examples, settings component 110 may be configured to identify the participation of the first user 102(1) in the event based on a nexus between the user data and the event. For example, the user data may include an indication that the user is an athlete associated with the Olympics and the event may include an Olympic competition. The settings component 110 may identify the trigger based on the association between the user and the Olympic competition.

In some examples, the settings component 110 may be configured to identify the participation of the first user 102(1) in the event based on the first interaction data and/or the second interaction data. In such examples, the settings component 110 may be configured to analyze content of posts, messages, comments, and/or the like transmitted between two or more user accounts and determine that the first user 102(1) is associated with the event. The settings component 110 may utilize natural language processing and/or other techniques to determine an association of the first user 102(1) with the event. For example, the settings component 110 may determine, based on content included in a post published by the first user 102(1), that the first user 102(1) is preparing for the Olympic competition. For another example, the settings component 110 may determine, based on content included in a post providing a teaser associated with a reality television show that is published by a second user 102(2) with a tag or mention of the first user 102(1), that the first user 102(1) is associated with the reality television show. The settings component 110 may identify the trigger based on the association with the reality television show.

In some examples, the settings component 110 may identify the trigger based on a determination that a current time is within a threshold time period (e.g., period of time) of a time associated with the event. The time may include an announcement of the event (e.g., first indication that the event will take place), an inception of the event (e.g., start time, first day, opening ceremony, first episode, etc.), and/or other time associated with the event. In some examples, the threshold time period (e.g., 1 hour, 12 hours, 24 hours, one week, one month) may include a user-defined amount of time prior to an event to identify a trigger. For example, an employee of the social networking system 106 may input the threshold time period associated with a particular event. In some examples, the settings component 110 may determine the threshold time period based on an event type associated with the event, an anticipated popularity of the event (e.g., based on historical data, statistical analysis, etc.), a duration of the event (e.g., how long the event lasts, etc.), and/or the like.

In various examples, the settings component 110 may be configured to determine a probability of increased activity and/or interactions by the other users 102(2)-102(n) with the user account in response to a participation (or anticipated participation), by the user, in the event. The probability of increased activity may be determined utilizing historical data associated with similar events and identified interactions with user accounts of participants of the similar events, an analysis of activity across the social networking system 106 during a period of time associated with the event (e.g., how much traction or activity is associated with the event on the social networking system, etc.), and/or the like. In various examples, the settings component 110 may be configured to identify the probability of increased activity utilizing machine learning techniques, statistical analysis, or another technique for identifying a probability of increased activity on, and/or interactions, with a user account. In various examples, identifying a trigger based on participation, by the first user 102(1), in the event, may be based at least in part on the probability of increased activity and/or interactions meeting or exceeding a threshold probability.

At operation 118 (indicated by “3”), the settings component 110 causes a presentation of a recommendation to update a setting associated with the user account. As discussed above, the setting may include a setting associated with other users commenting on one or more posts published by the first user 102(1), tagging, mentioning, or otherwise associating the user with a post generated by another user (e.g., second user 102(2)), sending a direct message to the first user 102(1), and/or the like. In some examples, the recommendation may include a recommendation to review settings associated with the user account, such as to verify that the settings are established as desired by the first user 102(1). In some examples, the recommendation may include an indicator associated with a new or updated setting available to the first user 102(1). For example, based on a change to a user account status (e.g., identified as an influencer, popular account with more than a threshold number of followers, etc.), the user account may be eligible for additional setting controls. Based on the change to the user account status, the settings component 110 may provide a recommendation to view the additional setting controls.

In various examples, the recommendation may include a recommendation to modify a particular setting, such as based on the trigger and/or identified interactions with the user account. For example, the recommendation may include a recommendation to modify permissions associated with commenting on any post published by the first user 102(1), such as to restrict commenting to only connections of the first user 102(1) (e.g., friends, people the first user 102(1) follows, followers of the first user 102(1), contacts, etc.). In some examples, the recommendation may include a recommendation to modify a setting associated with a particular post. For example, the recommendation may include a recommendation to turn on a bullying content filter associated with the post. In such examples, in response to receiving an indication to turn on the bullying filter content, the social networking system 106 may filter out comments associated with a post that are identified as including bullying content, such as that described above. In at least one example, the recommendation may include a recommendation to modify the setting to a more restrictive setting.

In various examples, the recommendation may be presented in a notification to the first user 102(1) presented on a display of the first computing device 104(1). The notification may include a pop-up notification, push notification, chat, or other type of notification. In at least one example, the notification may be presented in association with an instance of a social networking application, associated with the social networking system 106, and stored on the first computing device 104(1). In various examples, the notification and/or recommendation may include a selectable control that, when selected by the first user 102(1), enables the first user 102(1) to review and/or modify one or more settings associated with the user account.

In various examples, the settings component 110 may be configured to receive input associated with a modification to a setting of the user account. The settings component 110 may store the setting in association with the user account and may cause the social networking system to implement the modification. For example, a modification to a setting may include disabling a commenting function associated with a particular post. In response to receiving the input including the modification, the settings component 110 may cause the social networking system 106 to modify a user interface element associated with the post, disabling the commenting functionality. For another example, a modification to a setting may include modifying one or more recipients of posts published by the first user 102(1) in association with the user account (e.g., change from everyone can access to followers only). In response to receiving the input including the modification, the settings component 110 may cause the posts to be accessible to followers (e.g., contacts, friends, etc.) of the first user 102(1) (e.g., people connected to the user account).

In various examples, the settings component 110 may be configured to identify, at a time after the trigger occurs, that a circumstance associated with the trigger has reversed. That is, the settings component 110 may be configured to determine that the trigger that resulted in the recommendation is no longer active and/or valid. In some examples, an identification that the circumstance associated with the trigger has reversed may be determined based on interaction data received after the trigger. The interaction data may include data associated with the first user 102(1) and/or the other users 102(2)-102(n). For example, the trigger may include an identification, at a first time, of an increased amount and/or frequency of comments to one or more posts published in association with the user account. At a second time, after the first time, the settings component 110 may determine that the amount and/or frequency of comments to the post(s) associated with the user account returns to a normal amount and/or frequency. Based on determination that the amount and/or frequency of comments returns to the normal amount and/or frequency, the settings component 110 may determine that the circumstance associated with the trigger has reversed. For another example, the trigger may include a determination that the first user 102(1) is participating in an event associated with a high probability of increased attention and/or interactions with the user account. Based on a determination that the event is complete and/or a cool down period associated with attention from the event has passed (e.g., current time is after an end time or cool down period associated with the event), the settings component 110 may determine that the circumstance associated with the trigger has reversed.

Additionally or alternatively, the settings component 110 may be configured to identify a second trigger associated with the user account. In some examples, the second trigger may include a determination that a number and/or frequency of user interactions with the user account has decreased below a threshold amount and/or frequency. In some examples, the second trigger may include a determination that user interactions by the first user 102(1) and/or other users 102 has reduced to an average or normal level associated with the user account, such as that determined based on historical data. In some examples, the second trigger may include a determination that a number of contacts (e.g., friends, followers, connections, etc.) associated with the user account decreases below a threshold number of contacts. In various examples, based on an identification of the second trigger, the settings component 110 may determine that the circumstance associated with the (original) trigger is no longer valid or active. That is, the settings component 110 may determine that the amount, frequency, and/or type of user interactions that led to the original recommendation to update the setting associated with the user account no longer exist.

In various examples, based on a determination that the circumstance associated with the trigger has reversed (e.g., the trigger is no longer valid or active), the settings component 110 may cause a presentation of a second recommendation to review or update the setting associated with the user account. In some examples, the second recommendation may include a recommendation to reverse a first modification recommended and/or update based on the first recommendation. In at least one example, the second recommendation may include a recommendation to modify the setting to a less restrictive setting. In some examples, the second recommendation may include a recommendation to modify the setting to a previously established setting associated with the user account.

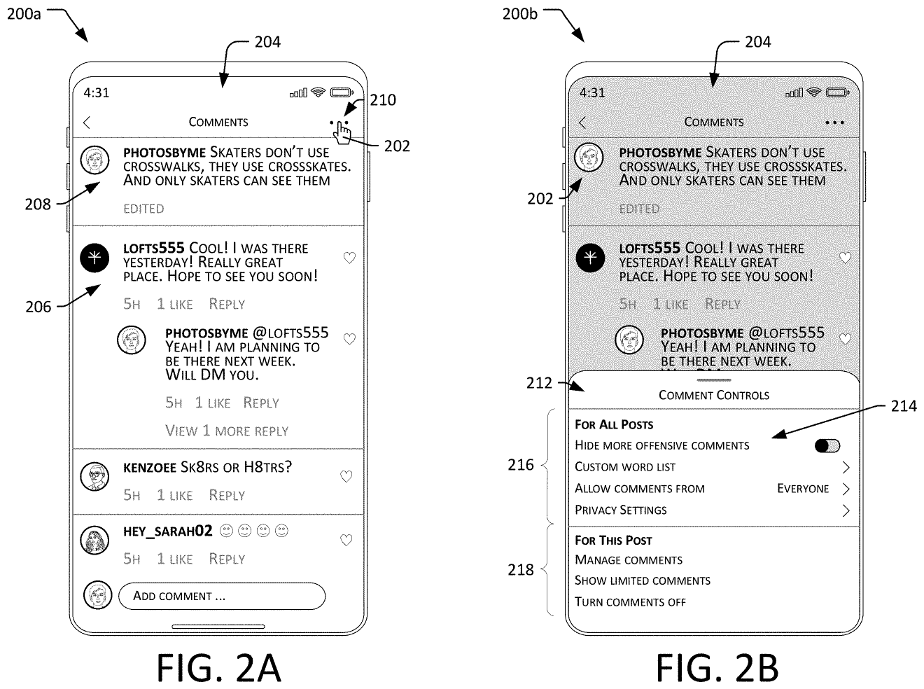

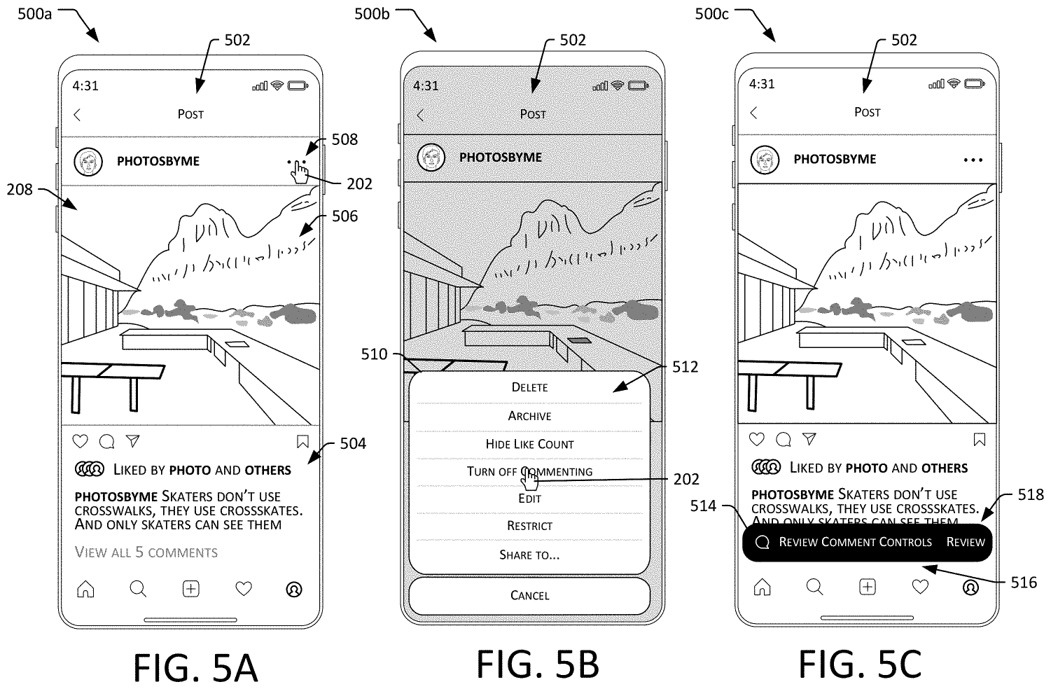

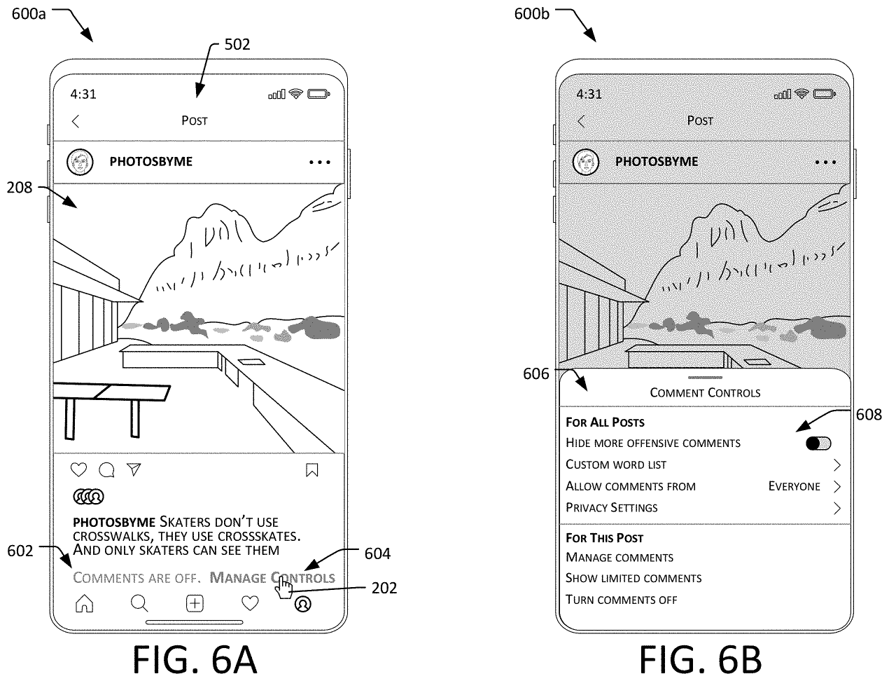

FIGS. 2A and 2B illustrate example interfaces associated with enabling a user 202 (illustrated as a cursor) access to comment control settings associated with a user account, as described herein. FIG. 2A illustrates an interface 200a in which a comment page 204 is presented. In various examples, the interface 200a may be presented via a computing device associated with the user 202, such as computing device 104(1) associated with the first user 102(1). The comment page 204 illustrates one or more comments 206 published by one or more users in response to a post 208 published by the user 202 in association with a user account thereof. In the illustrative example, the post 208 includes text published by the user. In some examples, and as illustrated below with respect to FIGS. 5A-5C and 6A and 6B, the comment page 204 may include a text portion of the post 208 that may additionally include one or more images, videos, GIFs, and/or the like. In examples in which the post 208 does not include text (e.g., images, video, etc. only), the comment page 204 may include comments, generated by the user and/or other users, in reaction to the images, videos, and/or the like.

In various examples, the comment page 204 may include an additional options control 210 that, when selected by the user 202, enables the user 202 to access one or more functionalities associated with the user account and/or managing comment controls associated therewith. In at least one example, the additional options control 210 enables the user to access a comment settings page in association with the comment page 204, the comment settings page including one or more controls associated with modifying setting(s) associated with comments posted in association with the user account. In some examples, the comment settings page may be presented as a pop-up window, a different page, a half-sheet or three-quarter sheet, other overlay, and/or the like.

FIG. 2B illustrates an interface 200b in which a comment settings page 212 is presented in association with the comment page 204. In the illustrative example, the comment settings page 212 is presented as a half-sheet overlayed on the comment page 204. In other examples, the comment settings page 212 may be presented as a window, another page, in a bifurcated interface 200b in which the comment page 204 is presented in a first portion and the comment settings page 212 is presented in a second portion, and/or the like.

In various examples, the comment settings page 212 may include one or more controls 214 associated with managing comments, by other users, to data posted in association with the user account. Non-limiting examples of the control(s) 214 include hiding offensive content (illustrated as “hide more offensive comments”), custom word list (e.g., enabling an illustration or filtering of particular words specified by the user 202), allowing comments from designated other users (e.g., friends only, people the user 202 follows, followers only, followers and people the user 202 follows, everyone, etc.), privacy settings associated with the comments, managing comments associated with a particular post, showing limited comments (e.g., top 10 comments, comments with kind, happy sentiment, etc.), turning comments off (e.g., disabling a commenting function associated with one or more posts), and/or the like.

In the illustrative example, the comment settings page 212 includes a first portion 216 including settings controls associated with the user account in general (e.g., settings controls “for all posts”) and a second portion 218 including settings controls associated with a particular post corresponding to the comment page 204. For example, the comment page 204 may include one or more comments associated with a particular post selected by the user, and the second portion 218 may include settings controls associated with managing comments associated with the particular post (e.g., post 208). Though illustrated as including different controls 214 in association with the first portion 216 and the second portion 218, this is not intended to be so limiting, and the same, similar, or different controls may be included in the first portion 216 and/or the second portion 218. For example, a manage comments control associated with the second portion 218 may enable the user 202 access to one or more controls associated with the first portion 216, such as to hide more offensive comments associated with the particular post, establish a custom word list, designate other users authorized to comment on the particular post, and/or establish privacy settings with regard to the particular post. For another example, a custom word list control associated with the first portion 216 and/or the second portion 218 may enable the user 202 to filter out comments (e.g., cause the social networking system to withhold from publication) including particular (designated or user 202 provided) words. In some examples, the particular words may be removed from a comment, while other words included in the comment may be published in association with the post 208. In response to receiving, from the user 202, input including one or more words to be filtered (in association with the custom word list control), the social networking system may analyze each comment and the content associated therewith to identify comments including the word(s) to be filtered. In response to identifying the word(s), the social networking system may withhold from presentation at least one of the associated comment(s) or the word(s) from the comments. That is, the social networking system may withhold the designated word(s) and/or comment(s) from presentation in association with the post 208.

In various examples, a settings component of the social networking system, such as settings component 110 of social networking system 106, may receive input from the user 202 via the comment settings page 212 and may update and/or modify one or more settings associated with a commenting function of the user account based on the input. In at least one example, the settings component may additionally store the modified and/or updated setting in association with the user account.

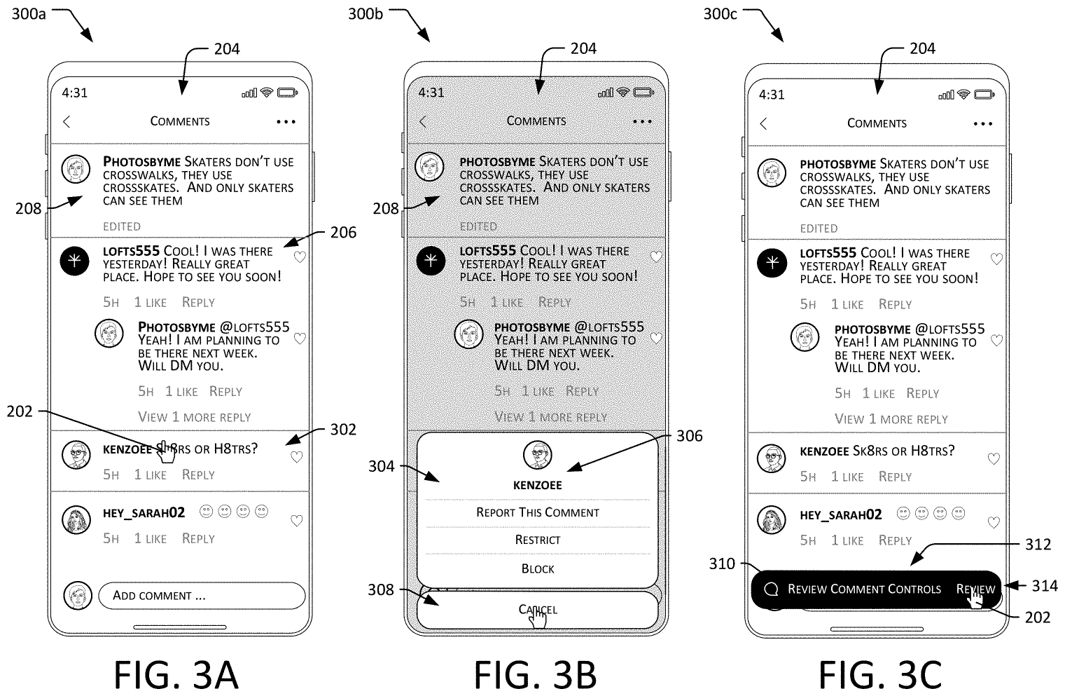

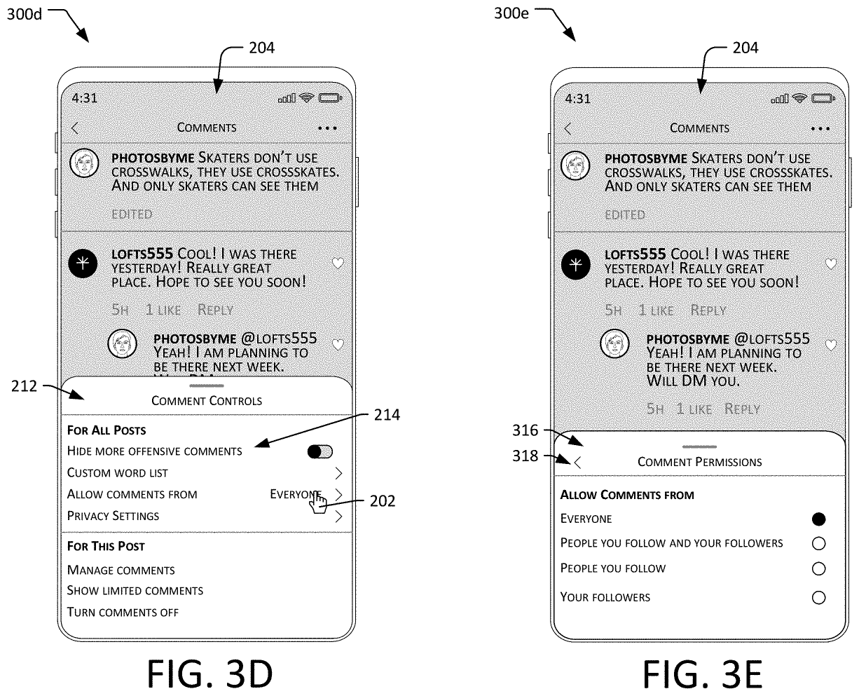

FIGS. 3A-3E illustrate example interfaces associated with detecting a trigger associated with providing a recommendation for a user 202 (illustrated as a cursor) to review comment control settings. FIG. 3A illustrates an interface 300a in which the comment page 204 is presented. As discussed above, the comment page 204 may include one or more comments 206 associated with a post 208 published by the user 202 in association with the user account. In various examples, the interface 300a may be presented via a computing device associated with the user 202, such as computing device 104(1) associated with the first user 102(1).

In various examples, the social networking system may receive an indication of selection, by the user 202, of a comment 302 of the one or more comments 206. In response to receiving the indication of selection of the comment 302, the social networking system may cause a comment control page to be presented in association with the comment page 204.

FIG. 3B illustrates an interface 300b in which a comment control page 304 is presented in association with the comment page 204. In at least one example, the comment control page 304 is present in response to a selection by the user 202 (e.g., a received indication of selection by the user 202) of a particular comment (e.g., comment 302) presented via the comment page 204. In the illustrative example, the comment control page 304 is illustrated as a pop-up window associated with the comment page 204. In other examples, the comment control page 304 may be presented as a half-sheet, a separate page (e.g., social networking system navigates to a page associated with the comment control page 304 that is different from the comment page 204), and/or the like. In the illustrative example, the comment control page 304 includes a first option to report the (selected) comment, such as to report the comment as offensive, bullying, aggressive or the like. In some examples, the social networking system may utilize a report associated with the first option to train one or more machine learned models to identify bullying content, as described above. In various examples, the model(s) may be trained and applied to a specific user account, such that the input from the user 202 may result in the model(s) learning about what types and/or levels of content the user 202 considers offensive, bullying, and/or the like.

In some examples, the comment control page 304 may include a second option associated with restricting a presentation of one or more comments in association with the post 208. In at least one example, the second option may include an option to restrict a presentation of the comment 302 in association with the post 208. In such an example, in response to receiving an indication of selection of the second option, the social networking system may remove, from presentation, the comment 302 in association with the post 208. In some examples, the second option may provide a means by which the user 202 may restrict another user 306 associated with the comment 302 (e.g., the other user who published the comment). In such examples, in response to receiving an indication of selection of the second option, the social networking system may disable a commenting control associated with one or more posts published by the user 202 and presented to the other user 306. That is, the social networking system may disable the commenting control on a user interface associated with the other user 306, while enabling the commenting control on interfaces associated with other users who are not restricted. In various examples, the social networking system may store an indication of the restriction in association with a user account of the user 202 and/or in association with another user account of the other user 306.

In some examples, the comment control page 304 may include a third option associated with blocking the other user 306 from accessing and/or viewing data associated with the user account. That is, in response to receiving an indication of selection of the third option, the social networking system may withhold access to data associated with the user account from presentation to the other user 306 via another user interface. Though illustrated as including the first, second, and third options, this is not intended to be so limiting, and additional or alternative selectable options may be presented in association with the comment control page 304, the additional or alternative selectable options including additional or alternative functionalities with respect to a commenting functionality provided by the social networking system in association with the user account.

In some examples, the comment control page 304 may have associated therewith a cancel control 308 via which the user 202 may cancel access to the comment control page 304. In response to receiving an indication of selection of the cancel control 308, the social networking system may present data associated with a previous page the user 202 was viewing when the selection of the comment 302 was received. That is, in response to receiving an indication of selection of the cancel control 308, the social networking system may cause the comment page 204 to be presented via the user interface 300b.

In various examples, the social networking system may identify a trigger associated with the user 202 navigating to the comment control page 304 and not selecting one of the first, second, third, or other options associated with one or more functionalities of the comment control page 304. In some examples, in response to identifying the trigger, the social networking system (e.g., a settings component 110 associated therewith) may cause a presentation of a recommendation to review or modify one or more comment controls associated with the user account. As discussed above, the recommendation may be provided in association with a notification presented to the user 202.

FIG. 3C illustrates a user interface 300c in which a notification 310 including a recommendation 312 to review or modify one or more comment controls is presented in association with the comment page 204. In various examples, the social networking system may cause a presentation of the notification including the recommendation 312 in response to identifying a trigger associated with the user account. As discussed above, in some examples, the trigger may be associated with a detected user interaction with the user account, such as a detection that the user 202 navigated to a comment control page 304, indicating an intent to perform an action with regard to the comment, and a determination that no action with regard to the comment was performed (e.g., indication of selection of the cancel control 308 was received).

In various examples, the notification 310 may be presented as a pop-up notification, an overlay on the user interface (e.g., half-sheet, three-quarter sheet, etc.), a highlight or headline associated with the user interface, or other means by which social networking system may draw attention to information provided in the notification. In various examples, the notification 310 may be presented for a period of time (e.g., 3 seconds, 5 seconds, 1 minute, etc.). In such examples, the notification 310 may include an ephemeral message to the user 202 providing information associated with the user account. In at least one example, the information may include the recommendation 312 to review comment control settings associated with the user account. For example, in response to identifying a trigger based on an identified intent of the user to perform an action with respect to the comment 302 (e.g., selection of the comment 302), and receiving an indication of selection of the cancel control 308, the social networking system generates the recommendation 312 to review the comment control settings.

In various examples, the notification 310 may include a review control 314 that, when selected by the user 202, enables the user 202 to view a comment settings page, such as comment settings page 212 described above with respect to FIG. 2B. FIG. 3D illustrates an interface 300d in which a comment settings page 212 is presented in association with the comment page 204. As described above, the comment settings page 212 may include one or more controls 214 associated with managing comments, by other users, to data posted in association with the user account. For example, in response to receiving an indication of selection of a control 214 associated with allowing comments from designated other users (e.g., friends only, people the user 202 follows, followers only, followers and people the user 202 follows, everyone, etc.), the social networking system may provide a means by which the user 202 may modify the comment control setting associated with permissions of other users to comment on post(s) published by the user.

FIG. 3E illustrates an interface 300e in which a comment permissions page 316 is presented in association with the comment page 204. The comment permissions page 316 may provide a means by which the user 202 may modify permissions associated with other users commenting on one or more posts published by the user 202. In some examples, the comment permissions page 316 may be associated with a selected post, such as post 208. In such examples, the user 202 may navigate to the comment permissions page 316 by selecting a “manage controls for this post” or similar option provided in a second portion of the comment settings page 212 (e.g., second portion 218 of FIG. 2B). In some examples, the comment permissions page 316 may be associated with the user account, in general, such that input provided via the comment permissions page 316 may be applied to all posts and/or other content posted in association with the user account.

In the illustrative example, the comment permissions page 316 includes options to designate select groups of users who may comment on posts published by the user 202. Non-limiting examples of the options include permitting comments from any other user authorized to view the post, other users that the user follows and users who follow the user, the other users that the user follows only, and/or the users who follow the user only. Though these are merely examples used to illustrate that the user 202 may select one or more other users and designate the user(s) as commentors (e.g., enable a commenting function associated with the user account(s) of the user(s) with respect to data posted by the user), and these examples are not intended to be so limiting.

In at least one example, the comment permissions page 316 includes a return control 318 that, when selected by the user 202, enables the user 202 to navigate back to one or more previous pages viewed by the user. In some examples, in response to receiving an indication of selection of the return control 318, the social networking system navigates back to (e.g., causes a presentation of) the comment settings page 212 as illustrated in FIG. 3D. In some examples, in response to receiving an indication of selection of the return control 318, the social networking system causes a presentation of the comment page 204.

In various examples, in response to receiving an indication of selection of at least one of an option to designate a group of one or more users as commentor(s) or the return control 318, the social networking system may store input associated with the comment permissions page 316 in association with the user account and/or one or more user accounts associated with the one or more users of the group. That is, based on the input selecting a particular option of the options presented via comment permissions page 316, the social networking system may modify permissions associated with the user account to reflect the input (e.g., enable commenting based on the selected group, restrict commenting for other users not included in the selected group, etc.).

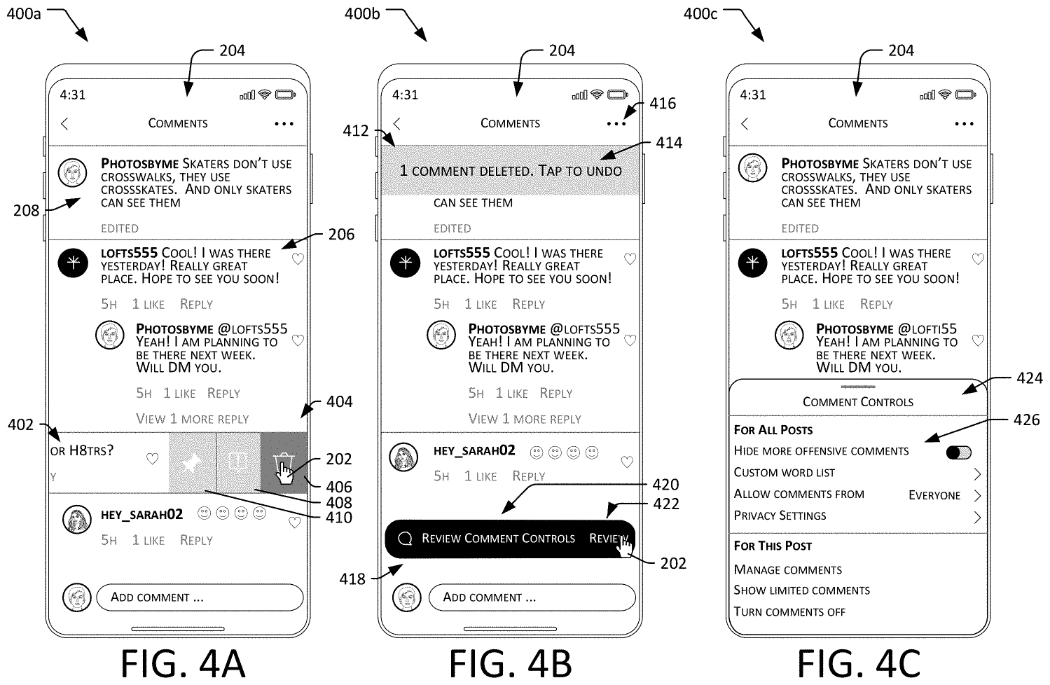

FIGS. 4A-4C illustrate example interfaces associated with detecting another trigger associated with providing a recommendation for a user 202 to review control settings, as described herein. FIG. 4A illustrates an interface 400a in which the comment page 204 is presented. As discussed above, the comment page 204 may include one or more comments 206 associated with a post 208 published by the user 202 in association with the user account. In various examples, the interface 400a may be presented via a computing device associated with the user 202, such as computing device 104(1) associated with the first user 102(1).

In various examples, the social networking system may receive an indication of selection, by the user 202, of a comment 402 of the one or more comments 206, such as comment 302. In at least one example, the indication of selection of the comment 402 may include a different type of selection, by the user 202 and associated with the comment, than that described above with regard to FIG. 3A. For example, the indication of selection described with regard to FIG. 3A may include a left click associated with the comment 302 and the indication of selection described with regard to FIG. 4A may include a right click, or vice versa. Additional or alternative types of selection are contemplated herein, such as a single click associated with a first indication of selection and a double click associated with a second indication of selection, selections of different durations, and/or the like.

In response to receiving the indication of selection of the comment 402, the social networking system may cause a presentation of one or more comment controls 404 associated with the comment to be presented in association with the comment page 204. In the illustrative example, the comment controls 404 include a pin control 406, a report control 408, and a delete control 410, though additional or alternative controls are contemplated herein, such as a block control, restrict control, and/or other controls associated with the comment 402. In various examples, the pin control 406 may be associated with pinning the comment 402 to a particular location on the user interface 400b, flagging or otherwise highlighting the comment 402, and/or the like. In some examples, the report control 408 may provide a quick and efficient (e.g., one-click) means by which the user 202 can report the comment as offensive, bullying, aggressive or the like. As discussed above, the social networking system may utilize the report (e.g., input from the user) to train one or more machine learned models to identify offensive, bullying, and/or aggressive content.

In various examples, the delete control 410 may enable the user to quickly and efficiently (e.g., with one click) remove the comment 402 from presentation in association with the post 208. In such examples, in response to receiving an indication of selection of the delete control 410, the social networking system may withhold data associated with the comment 402 from view via the comment page 204 and/or other pages associated with the post 208 (e.g., a messaging feed, etc.).

FIG. 4B illustrates an interface 400b in which the comment page 204 is presented after a deletion of a comment 402 therefrom. In at least one example, the comment 402 may be deleted from the comment page 204 in response to receiving an indication of selection, by the user 202, of a delete control 410 associated with the comment 402.

As discussed above, in response to receiving the indication of selection of the delete control 410, the social networking system may withhold data associated with the comment 402 from presentation via the comment page 204. Additionally, the social networking system may delete or otherwise remove the comment 402 from a data store associated with the user account of the user 202 and/or another data store of the social networking system (e.g., data store associated with the other user who published the comment 402).

In at least one example, in response to receiving the indication of selection of the delete control 410, the social networking system may cause a presentation of a first notification 412 in association with the comment page 204. The first notification 412 may provide an indication that a comment 402 associated with the comments page 204 (e.g., associated with the post 208) was deleted, such as to alert the user 202 as to the action performed (e.g., comment deletion). In at least one example, the first notification may include an undo control 414 that, when selected by the user 202, causes the comment 402 to be presented in association with the post 208. That is, the undo control 414 enables the user 202 to undo the deletion of the comment 402.

In various examples, the first notification 412 may be presented on the comment page 204 for a first period of time (e.g., 2 second, 4 seconds, 6 seconds, etc.), providing a finite amount of time in which the user 202 may undo the deletion. In some examples, the social networking system may provide an additional or alternative deletion control in association with an additional options control 416, such as additional options control 210, associated with the comment page 204. That is, the social networking system may provide an additional or alternative means by which the user 202 may undo the deletion, such as a long-lasting, persistent option (e.g., non-ephemeral) to undo the deletion of the comment 402.

In various examples, the first notification 412 may be presented as a pop-up window, a half-sheet or three-quarter sheet, other overlay, inset notification, and/or the like. Additionally, though illustrated as being presented at the top of the comment page 204, this is not intended to be so limiting, and the first notification 412 may be presented at any other location of the comment page 204 (e.g., side of the page, bottom of the page, etc.).

As illustrated in FIG. 4B, the interface 400b may additionally or alternatively include a second notification 418 including a recommendation 420 to review or modify one or more comment controls is presented in association with the comment page 204, such as notification 310 including recommendation 312. In various examples, the social networking system may cause a presentation of the second notification 418 including the recommendation 420 in response to identifying a trigger associated with the user account. As discussed above, in some examples, the trigger may be associated with a detected user interaction with the user account, such as an identification that the user performed one or more actions with respect to a comment (e.g., deleted the comment, reported the comment, blocked a user account associated with the comment, etc.). In the illustrative example, the social networking system identifies the trigger in response to a detected deletion, by the user 202, of the comment 402, such as that described with regard to FIG. 4A.

In various examples, the second notification 418 may be presented as a pop-up notification, an overlay on the user interface (e.g., half-sheet, three-quarter sheet, etc.), a highlight or headline associated with the user interface, or other means by which social networking system may draw attention to information provided in the second notification. In various examples, the second notification 418 may be presented for a second period of time (e.g., 3 seconds, 5 seconds, 1 minute, etc.). The second period of time may be the same or a different period of time than the first period of time associated with the first notification.

In various examples, the second notification 418 may include a review control 422 that, when selected by the user 202, enables the user 202 to view a comment settings page, such as comment settings page 212 described above with respect to FIG. 2B. FIG. 4C illustrates an interface 400c in which a comment settings page 424 is presented in association with the comment page 204. As described above, the comment settings page 424 may include one or more controls 426 associated with managing comments, by other users, to data posted in association with the user account, such as control(s) 214.

FIGS. 5A-5C illustrate example interfaces associated with yet another trigger associated with providing a recommendation for a user 202 (illustrated as a cursor) to review control settings, as described herein. FIG. 5A illustrates an interface 500a in which a post page 502 is presented. In various examples, the interface 500a may be presented via a computing device associated with the user 202, such as computing device 104(1) associated with the first user 102(1).

In various examples, the post page 502 may include a post drafting page via which the user 202 may generate and publish a post 208. In some examples, the user 202 can navigate to the post page 502 by selecting a compose post selectable control associated with another user interface corresponding to the social networking system (e.g., associated with a social networking system application). In some examples, the post page 502 can include a post editing page via which the user 202 may edit one or more features of the post 208 (e.g., settings, text, images, etc.). In some examples, the user 202 can navigate to the post page 502 via a messaging feed, a user profile, a story, and/or the like associated with the user account. The messaging feed, the user profile, the story, and/or the like can include one or more posts published by the user 202. The messaging feed may additionally include post(s) published by one or more other users with whom the user 202 is connected. In some examples, the user 202 can select an edit control associated with the post 208, and presented in association with the post published in the messaging feed, the user profile, the story, and/or the like. In such examples, in response to receiving an indication of selection of the edit control associated with the post 208, the social networking system may cause the post page 502 to be presented via the interface 500a.

The post page 502 illustrates the post 208 generated by the user 202 in association with a user account thereof. In the illustrative example, the post 208 includes a text portion 504, such as that illustrated in FIGS. 2A-4C, and an image portion 506 including a single image. In other examples, the post 208 may include one or more images, GIFs, videos, and/or the like, with or without a text portion including a description or communication composed by the drafting user.

In various examples, the post page 502 may include an additional options control 508 that, when selected by the user 202, enables the user 202 to access one or more functionalities associated with the post 208. In at least one example, the additional options control 508 enables the user 202 to access a post settings page in association with the post 208, the post settings page including one or more controls associated with modifying setting(s) associated with the post 208 published or to be published in association with the user account. In some examples, the post settings page may be presented as an overlay window, a different page, a half-sheet, and/or the like.

FIG. 5B illustrates an interface 500b in which a post settings page 510 is presented in association with the post page 502. In at least one example, the post settings page 510 is present in response to a selection by the user 202 (e.g., a received indication of selection by the user 202) of an additional options control 508 associated with a post (e.g., post 208) presented via the post page 502. In the illustrative example, the post settings page 510 is illustrated as an overlay window associated with the post page 502. In other examples, the post settings page 510 may be presented as a half-sheet, a separate page (e.g., social networking system navigates to a page associated with the post settings page 510 that is different from the post page 502), and/or the like.

In various examples, the post settings page 510 may include control options 512 associated with the post 208. In the illustrative example, the control options 512 include a deletion option (e.g., to delete the post 208), an archive option (e.g., to cause the post 208 to be stored in a long term storage data base, etc.), a hide like count option (e.g., to withhold from presentation one or more reactions to the post 208 by other users), a disengage commenting option (e.g., to disable a commenting functionality associated with the post 208), an edit option (e.g., to edit the post 208), a restriction option (e.g., to restrict access to the post 208 to a select group of users), a share option (e.g., to share the post 208 with select users, such as via direct message), and a cancel option (e.g., to cancel performing any of the available functions associated with the post 208). The illustrated list of options, however, is not intended to be so limited, and additional or alternative options are contemplated herein.

In various examples, in response to receiving an indication of selection of a control option 512, the social networking system enables the functionality associated therewith. For example, in response to receiving an indication of selection of the edit option, the social networking system can enable the user 202 to modify one or more characteristics of the post 208, such as to add or delete an image associated with the image portion 506, modify the text portion 504, and/or the like. For another example, in response to receiving an indication of selection of the restriction option, the social networking system can limit access permissions of the post 208 to one or more other users designated in the restriction. That is, the social networking system may enable the designated other users to view the post 208, such as via a messaging feed or a user profile of the user 202, but may disable permissions associated with other users (e.g., other than those designated) viewing the post 208. In at least one example, in response to receiving an indication of selection of the disengage commenting option, the social networking system can disable a commenting functionality associated with the post 208, such as to restrict other users from commenting on the post 208.

In various examples, one or more of the options 512 presented in association with the post settings page 510 may be associated with a trigger for recommending review or modification to one or more settings associated with the user account. That is, in response to receiving an indication of selection of one or more of the option(s) 512, the social networking system may identify the trigger and cause a notification including a recommendation to be presented to the user 202 in association with the post page 502. FIG. 5C illustrates an interface 500c in which a notification 514 including a recommendation 516 to review or modify one or more comment controls is presented in association with the post page 502.

In various examples, the social networking system may cause a presentation of the notification 514 including the recommendation 516 in response to identifying the trigger associated with the user account. As discussed above, in some examples, the trigger may be associated with a detected user interaction with the user account, such as a detection that the user 202 selected a disengage commenting option associated with a post settings page 510. Though illustrated as a recommendation 516 to review or modify one or more comment controls, this is not intended to be so limiting, and additional or alternative recommendations may be presented in response to the trigger associated with selection of an option 512. For example, in response to receiving an indication of selection of the restriction option, the social networking system may identify a trigger associated with connections, of other users, with the user account. In such an example, the social networking system may cause a recommendation to review connection settings associated with the user account in the notification 514.

In various examples, the notification 514 may be presented as a pop-up notification, an overlay on the user interface (e.g., half-sheet, three-quarter sheet, etc.), a highlight or headline associated with the user interface, or other means by which social networking system may draw attention to information provided in the notification. In various examples, the notification 514 may be presented for a period of time (e.g., 3 seconds, 5 seconds, 1 minute, etc.). In such examples, the notification 514 may include an ephemeral message to the user 202 providing information associated with the user account. In at least one example, the information may include the recommendation 516 to review comment control settings associated with the user account. For example, in response to identifying the trigger based on a selection of the disengage commenting option, the social networking system generates the recommendation 516 to review the comment control settings.

In various examples, the notification 514 may include a review control 518 that, when selected by the user 202, enables the user to view a comment settings page, such as comment settings page 212 described above with respect to FIG. 2B.

FIGS. 6A and 6B illustrate example interfaces associated with enabling a user 202 access to comment control settings associated with a post 208, as described herein. FIG. 6A illustrates an interface 600a including the post page 502 after a disengagement of the commenting function associated with the post 208, such as that described above with regard to FIGS. 5A-5C. In various examples, the social networking system may cause a presentation of an indication 602 that the commenting function associated with the post 208 is disengaged. Additionally, in some examples, the social networking system may cause a presentation of a manage comments control 604 that, when selected by the user 202, enables the user to view and/or modify one or more settings associated with the post 208 and/or a commenting functionality associated therewith. FIG. 6B illustrates an interface 600b in which a comment settings page 606, such as comment settings page 212 is presented in association with the post page 502. In at least one example, the comment settings page 606 may be presented in association with the post page 502 in response to receiving an indication of selection, by the user 202, of the manage comments control 604.

As described above, the comment settings page 606 may include one or more controls 608, associated with managing comments, such as control(s) 214, by other users, to data posted in association with the user account. For example, in response to receiving an indication of selection of a control 608 associated with allowing comments from designated other users (e.g., friends only, people the user 202 follows, followers only, followers and people the user 202 follows, everyone, etc.), the social networking system may provide a means by which the user 202 may modify the comment control setting associated with permissions of other users to comment on post(s) published by the user.

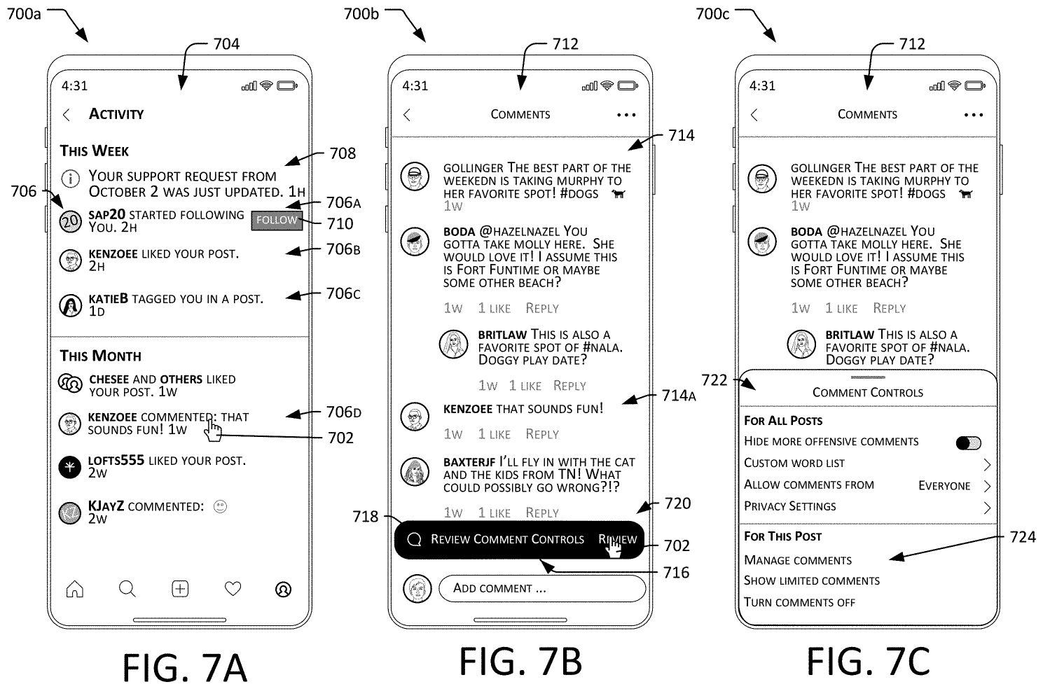

FIGS. 7A-7C illustrate example interfaces associated with detecting an activity-based trigger associated with providing a recommendation for a user 702 (illustrated as a cursor) to review control settings, as described herein. FIG. 7A illustrates an interface 700a in which an activity page 704 is presented. In at least one example, the activity page 704 includes data associated with one or more interactions, by other users, with the user account. In various examples, one or more of the interaction(s) may be represented by an interaction indicator 706, which may provide a synopsis of the interaction(s). As discussed above, the interactions can include other users commenting on a post (e.g., post 208), reacting to a post, “liking” or otherwise affirming the post, tagging the user 202 associated with the user account in a post published by the other user, mentioning the user 202 associated with the user account in a post published by the other user, recent connections with other users, and/or the like. For example, interaction indicator 706a includes an indication that another user (e.g., SAP20) connected with the user 702 (e.g., started following). For another example, an interaction indicator 706b includes an indication that another user (e.g., KENZOEE) liked a post, such as post 208. For yet another example, an interaction indicator 706c includes an indication that another user (e.g., KATIEB) tagged the user 702 in a post. For still yet another example, an interaction indicator 706d includes an indication that another user (e.g., KENZOEE) commented on a post. In some examples, an indication that another user commented on a post, such as illustrated in association with the interaction indicator 706d, may include at least a portion of the comment (e.g., text, image(s), GIF(s), emoji(s)), and/or the like included in the comment.

Additionally or alternatively, the activity page 704 may include update information 708 associated with the user account. For example, the update information 708 may include an indication that the user account has been updated based on a support request, that a new functionality with respect to the user account is available, that a status associated with the user account has been updated, and/or the like.

In various examples, the interaction indicator(s) 706 may have associated therewith one or more selectable controls, configured for user 702 interaction therewith. That is, the social networking system may configure one or more of the interaction indicator(s) 706 for user interaction, such as to enable the user to perform one or more actions with respect to a respective interaction indicator 706. In some examples, the action(s) may include viewing additional data associated with the interaction indicator 706 (e.g., access and/or view a post associated with a comment, post, tag, etc.) and/or performing a reactive action associated with the action performed by the other user, such as via a selectable control 710. In at least one example, a reactive action associated with a new connection or a new connection request may include accepting the new connection, approving the new connection request, and/or establishing a two-way connection (e.g., user 702 is followed by the other user and also follows the other user). For example, the interaction indicator 706a includes an indication that another user (e.g., SAP20) connected with the user 702 (e.g., started following). The interaction indicator 706a also includes a selectable control 710 that enables the user 702 to establish a two-way connection with the other user.

In at least one example, the interaction indicator 706 may, itself, be selectable (e.g., interaction indicator 706 includes the selectable control) to enable the user 702 to view the data associated with the selected interaction. In such an example, the selectable control associated with an interaction indicator 706 may be separate and distinct from the interaction indicator 706. For example, in response to receiving an indication of selection of an interaction indicator 706 associated with a comment posted by another user in response to a post published by the user 702, such as interaction indicator 706d, the social networking system may cause a presentation of a comments page, such as comment page 204, via an interface.

FIG. 7B illustrates an interface 700b in which a comment page 712 associated with a particular post, such as post 208, is presented. In at least one example, the social networking system may cause the comment page 712 to be presented in response to receiving an indication of selection of an interaction indicator 706 presented via the activity page. In such an example, the social networking system may identify a post associated with a selected interaction indicator 706, and one or more comments 714 associated therewith, and may cause the comment(s) to be presented via the comment page 712. For example, in response to receiving an indication of selection, by the user 702, of the interaction indicator 706d, the social networking system identifies a post associated with the particular interaction indicator 706d and one or more comments 714 associated with the post, such as comment 714a that corresponds to the interaction indicator 706d.

In various examples, the comment page 712 may provide a means by which the user 702 can review other comments 714 posted in association with the comment 714a corresponding to the interaction indicator 706d, respond to one or more of the comment(s) 714, and/or perform one or more actions associated with the comment(s) 714 (e.g., report, delete, restrict, etc.), as described above. In various examples, the social networking system may identify a trigger based on the user 702 interaction with the activity page 704. That is, in response to receiving an indication of selection of the interaction indicator 706d, the social networking system may identify a trigger associated with a recommendation 716 to review and/or modify settings associated with the user account, such as recommendation 312, recommendation 420, and/or recommendation 516.

In various examples, based on an identification of the trigger, the social networking system may cause a notification 718, such as notification 310, notification 418, and/or notification 514 including the recommendation 716 to be presented in association with the comment page 712. As discussed above, the notification 718 may be presented as a pop-up notification, an overlay on the user interface (e.g., half-sheet, three-quarter sheet, etc.), a highlight or headline associated with the user interface, or other means by which social networking system may draw attention to information provided in the notification. In various examples, the notification 718 may be presented for a period of time (e.g., 3 seconds, 5 seconds, 1 minute, etc.). In such examples, the notification 718 may include an ephemeral message to the user 702 providing information associated with the user account. In at least one example, the information may include the recommendation 716 associated with the identified trigger (e.g., to review comment control settings associated with the user account).

As illustrated in FIG. 7B, the notification 718 may include a review control 720 that, when selected by the user 702, enables the user 702 to view a comment settings page, such as comment settings page 212, comment settings page 424, and/or the like. FIG. 7C illustrates an interface 700c in which a comment settings page 722 is presented in association with the comment page 712. As described above, the comment settings page 722 may include one or more controls 724 associated with managing comments, by other users, to data posted in association with the user account. As discussed above, the control(s) 724 may be associated with a particular post and/or with the user account, in general (e.g., for all posts published in association with the user account).

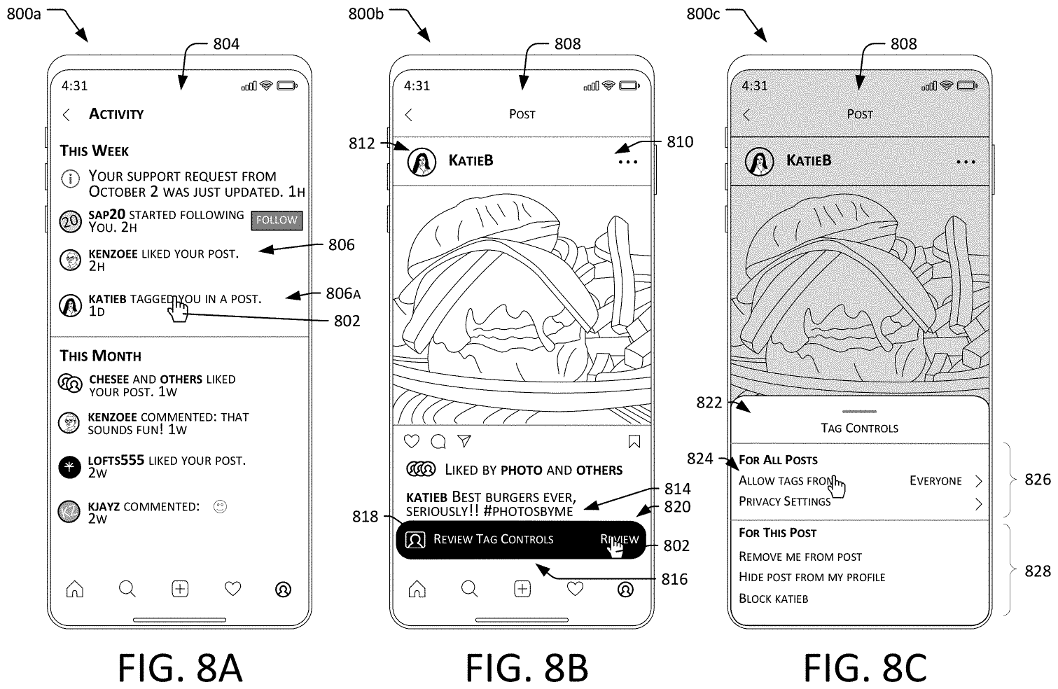

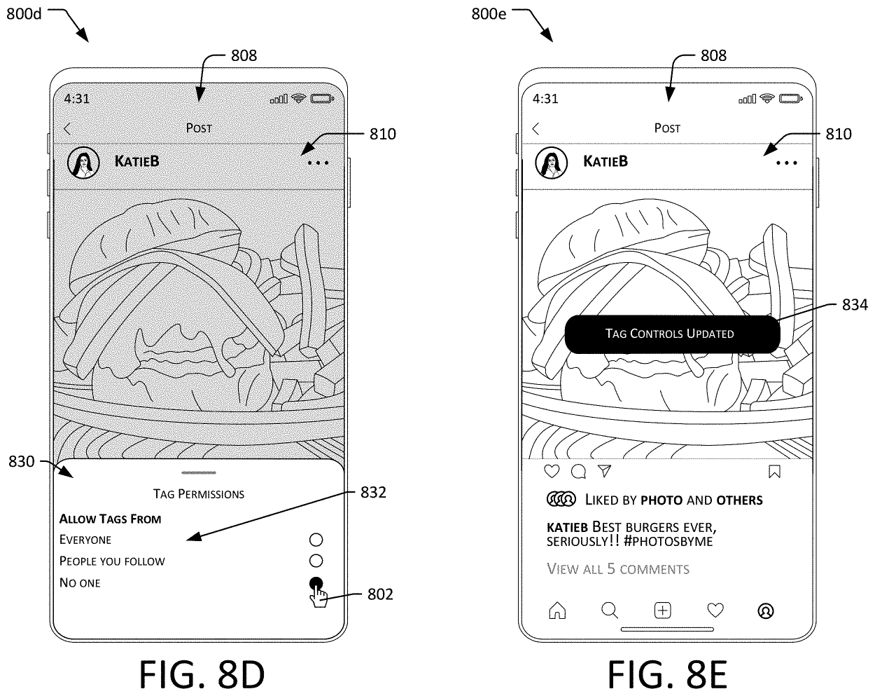

FIGS. 8A-8E illustrate example interfaces associated with detecting a trigger associated with providing a recommendation for a user 802 to review tag control settings associated with a user account, as described herein. FIG. 8A illustrates an interface 800a in which an activity page 804 is presented, such as activity page 704 of FIG. 7A. In at least one example, the activity page 804 includes data associated with one or more interactions, by other users, with the user account. As discussed above, one or more of the interaction(s) may be represented by an interaction indicator 806, which may provide a synopsis of the interaction(s) (e.g., details associated with the interaction, at least a portion of content associated therewith, etc.). In at least one example, an interaction may include another user tagging the user 802 associated with the user account in a post, such as that published by any other user of the social networking system in a post that is accessible to the other user (e.g., the tagging user). For example, interaction indicator 806a (e.g., interaction indicator 706c) indicates that another user (e.g., KATIEB) tagged the user 802 in a post.

As discussed above, the interaction indicator(s) 806 may have associated therewith, one or more selectable controls to enable the user 802 to view the data associated with a selected interaction. For example, in response to receiving an indication of selection of an interaction indicator 806a associated with a tag interaction (e.g., the other user tagging the user 802), the social networking system may cause a presentation of a post page, such as post page 502, via an interface. FIG. 8B illustrates an interface 800b in which a post page 808 associated with a post 810 is presented to the user 802, such as in response to a selection of an interaction indicator 806, such as interaction indicator 806a. The post 810 may include the post in which another user 812 tagged the user 802. For example, the other user 812 associates a tag 814 of the user 802 with the post 810. Though illustrated as including a hashtag with a name (e.g., username) of the user 802, this is not intended to be so limiting, and the tag 814 may include additional or alternative embodiments, such as tag symbol that is linked to an identification of the user 802, the user account, and/or the like.

In various examples, the post page 808 may provide a means by which the user 802 can review data associated with the post 810 corresponding to the selected interaction indicator 806a described in FIG. 8A, react to the post 810, publish a comment associated with the post 810, report the post, block the other user 812 from the user account of the user 802, and/or the like. In at least one example, the social networking system may identify a trigger based on the user 802 interaction with the activity page 804 and/or the post page 808. For example, in response to receiving an indication of selection of the interaction indicator 806a, the social networking system may identify a trigger associated with a recommendation 816 to review and/or modify settings associated with the user account, such as recommendation 312, recommendation 420, recommendation 516, and/or recommendation 716. In at least one example, the recommendation 816 may include a recommendation to review and/or modify settings associated with one or more tags, by other users, of the user 802 and/or the user account, such as tag 814 by the other user 812. That is, the recommendation 816 may include a recommendation to the user to review controls or settings associated with who can tag the user 802 and/or the context (e.g., in private posts, public posts, ephemeral content items, etc.) associated with the tag.

In various examples, based on an identification of the trigger, the social networking system may cause a notification 818, such as notification 310, notification 418, notification 514, and/or notification 718, including the recommendation 816 to be presented in association with the post page 808. As discussed above, the notification 818 may be presented as a pop-up notification, an overlay on the user interface (e.g., half-sheet, three-quarter sheet, etc.), a highlight or headline associated with the user interface, or other means by which social networking system may draw attention to information provided in the notification. In various examples, the notification 818 may be presented for a period of time (e.g., 3 seconds, 5 seconds, 1 minute, etc.). In such examples, the notification 818 may include an ephemeral message to the user 802 providing information associated with the user account. In at least one example, the information may include the recommendation 816 associated with the identified trigger (e.g., to review comment control settings associated with the user account).

As illustrated in FIG. 8B, the notification 818 may include a review control 820 that, when selected by the user 802, enables the user 802 to view a tag settings page, such as to review and/or modify one or more settings associated with tags. FIG. 8C illustrates an interface 800c in which a tag settings page 822 is presented in association with the post page 808. In the illustrative example, the tag settings page 822 is presented as a half-sheet overlayed on the post page 808. In other examples, the tag settings page 822 may be presented as a window, another page, in a bifurcated interface in which the post page 808 is presented in a first portion and the tag settings page 822 is presented in a second portion, and/or the like.

In various examples, the tag settings page 822 may include one or more controls 824 associated with managing tags, by other users, of the user 802 and/or the user account. Non-limiting examples of the control(s) 824 allowing tags from designated other users (e.g., friends only, people the user 802 follows, followers only, followers and people the user 802 follows, everyone, etc.), privacy settings associated with the tags, removing the tag 814 from the post 810, hiding the post 810 from a profile associated with the user account, disabling tags in association with the user account, and/or the like.

In the illustrative example, the tag settings page 822 includes a first portion 826 including tag settings controls associated with the user account in general (e.g., settings controls “for all posts”) and a second portion 828 including tag settings controls associated with a particular post corresponding to the post page 808 (e.g., post 810). Though illustrated as including different controls 824 in association with the first portion 826 and the second portion 828, this is not intended to be so limiting, and the same, similar, or different controls may be included in the first portion 826 and/or the second portion 828. For example, a privacy settings control presented in associated with the second portion 828 may enable the user 802 manage privacy settings associated with the particular post 810 and/or the other user 812.

In at least one example, the tag settings page 822 includes a control 824 associated with managing permissions associated with tags, such as to indicate a group of other users authorized to tag the user 802 and/or the user account in a post. For example, the control 824 associated with managing the permissions associated with tags may enable the user to modify a setting associated therewith, such as to change a setting from a first setting (e.g., any other user can tag the user 802) to a second setting (e.g., only a select group of other users can tag the user 802). In various examples, in response to receiving an indication of selection of the control 824, the social networking system may cause a tag permissions page to be presented via an interface.

FIG. 8D illustrates an interface 800d in which a tag permissions page 830 is presented in association with the post page 808. The tag permissions page 830 may provide a means by which the user 802 may modify permissions associated with other users tagging the user 802 in one or more posts published via the social networking system. In some examples, the tag permissions page 830 may be associated with a selected post, such as post 810. In such examples, the user 802 may navigate to the tag permissions page 830 by selecting a control associated with managing tags for this post or similar option provided in a second portion of the tag settings page 822 (e.g., second portion 828 of FIG. 8C). In at least one example, the tag permissions page 830 may be associated with the user account, in general, such that input provided via the tag permissions page 830 may be applied to all posts and/or other content posted in association with the user account. For example, the user 802 may navigate to the tag permissions page 830 by selecting a control associated with managing tags for all posts or similar option provided in a first portion of the tag settings page 822 (e.g., first portion 826 of FIG. 8C).

In the illustrative example, the tag permission page 830 includes options 832 to designate select groups of users who may tag the user 802 in one or more posts published via the social networking system. Non-limiting examples of the options 832 include permitting tags by any other user authorized to view the post (e.g., everyone), other users whom the user 802 follows, other users that the user follows and users who follow the user, the users who follow the user 802 only, and/or disabling tags associated with the user account. Though these are merely examples used to illustrate that the user 802 may select one or more other users and enable a tag of the user 802 in a post associated therewith (e.g., enable a tagging function associated with the user account(s) of the user(s) with respect to data posted by the user 802), and these examples are not intended to be so limiting.

In various examples, in response to receiving an indication of selection of at least one of an option 832 to designate a group of one or more users as users who may tag the user 802, the social networking system may store input associated with the tag permission page 830 in association with the user account and/or one or more user accounts associated with the one or more users of the group. That is, based on the input selecting a particular option of the options 832 presented via tag permissions page 830, the social networking system may modify permissions associated with the user account to reflect the input (e.g., enable tagging based on the selected group, restrict tagging for other users not included in the selected group, etc.). For example, in response to receiving an indication of selection of an option 832 to allow no other users (e.g., no one) to tag the user 802 in association with posts published via the social networking system, the social networking system may store an indication of the updated tag permissions in association with the user account.

In at least one example, the social networking system may be configured to cause a presentation of an update indication via the post page 808, such as to verify to the user that the tag permission has been modified and/or updated. FIG. 8E illustrates an interface 800e in which an update indication 834 is presented in association with the post page 808. In the illustrative example, the update indication 834 includes an indication that the tag permissions have been updated (e.g., tag controls updated). Though this is merely presented as an illustrative example, and additional or alternative indications are contemplated herein, such as an indication of a specific tag control that was modified, an indication of whether the update is associated with the post 810 and/or the entire user account, and/or the like.

In various examples, the update indication 834 may be presented for a period of time (e.g., 1.5 seconds, 2 seconds, etc.) in association with the post page 808. That is, the update indication 834 may include an ephemeral notification that provides information to the user 802 about the tag permissions modification. In some examples, the update indication 834 may include a selectable control, that, when selected by the user 802, enables the user 802 to navigate back to the tag settings page 822 and/or the tag permissions page 830.

Though described herein as reviewing and/or modifying permissions associated with tags, it is understood that the techniques described herein may additionally or alternatively be applied to controlling a mentioning functionality with regard to the user account. That is, the social networking system may identify a trigger associated with a mention (e.g., @mention, !mention, etc.) of the user account and/or the user 802 (e.g., username, real name, etc.), and may cause a recommendation to review and/or modify mention control settings associated with the user interface, as described herein with regard to tag controls, comment controls, message controls, and the like.

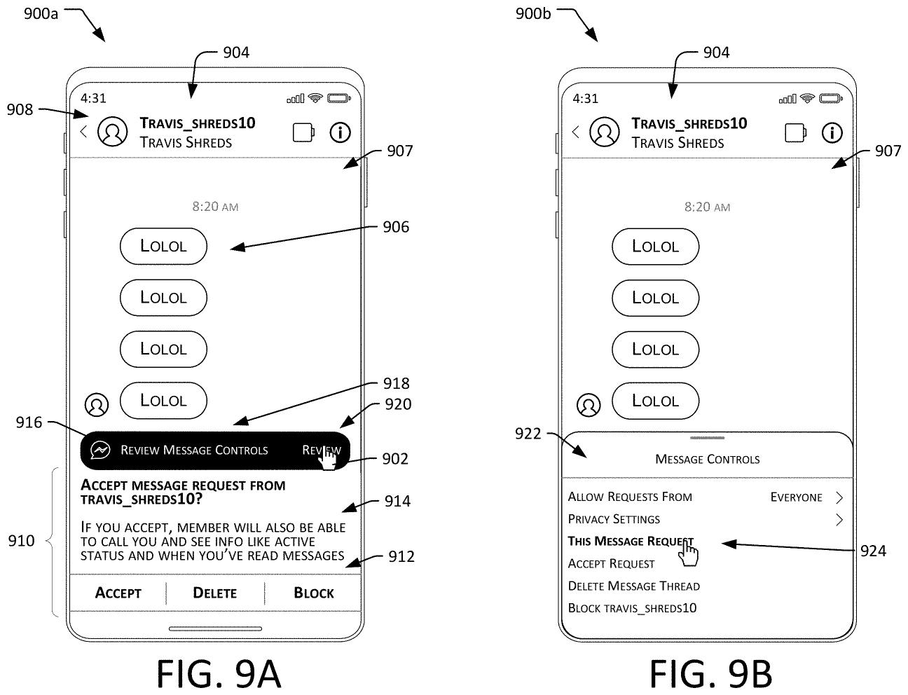

FIGS. 9A and 9B illustrate example interfaces associated with detecting a trigger associated with providing a recommendation for a user 902 (illustrated as a cursor) to review message control settings associated with a user account, as described herein. FIG. 9A illustrates an example interface 900a in which a messaging page 904 is presented. In various examples, the messaging page 904 may include one or more messages 906 transmitted between the user 902 and at least one other user (e.g., the other user 908). In at least one example, the messaging page 904 may be associated with a direct messaging instance between the user 902 and the other user 908. In such an example, the messaging page 904 may be associated with private messages accessible by members of the direct messaging instance (e.g., the user 902 and the other user 908). In various examples, the interface 800a may be presented via a computing device associated with the user 902, such as computing device 104(1) associated with the first user 102(1).

In various examples, the other user 908 may be associated with another user account that is connected to a user account of the user 902, such as a friend, follower, contact, and/or the like. In some examples, the other user 908 may be associated with another user account that is not connected to the user account of the user 902. In at least one example, in response to determining that the other user 908 and the user 902 are not connected via the social networking system, the social networking system may cause an acceptance element 910 to be presented via the messaging page 904. The acceptance element 910 may provide a means by which the user 902 may perform one or more actions 912 associated with a messaging instance 907 between the user 902 and the other user 908. The action(s) 912 may include accepting the messaging instance 907, such as to enable the user 902 and the other user 908 to transmit messages 906 to one another, a deleting the messaging instance 907, such as to remove the messaging instance 907 from presentation in association with the user account of the user 902 and/or another user account of the other user 908, and a blocking action, such as to enable the user 902 to block the other user 908 from sending subsequent messages 906 to the user 902.

Additionally, in some examples, the acceptance element 910 may include a warning 914 providing the user 902 with an indication of consequences associated with accepting an invitation to communicate via the messaging instance 907. In the illustrative example, the consequences include permissions modifications that will occur with respect to data the other user 908 will be able to view in response to a selection of an accept action 912 (e.g., the other user 908 will be able to call the user 902, view a status indicator associated with the user 902, see when the user 902 has read a message 906, etc.), though this is not intended to be so limiting, and the content of the warning 914 may include additional or alternative consequences.

In various examples, the social networking system may identify a trigger associated with the messaging page 904 based on one or more interactions, by the user 902, with the messaging page 904. As discussed above, the trigger may include a triggering action associated with a recommendation to review or modify one or more settings associated with the user account. In some examples, a mere navigation to the messaging page 904, by the user 902, may cause a trigger. That is, in response to receiving an indication of selection of an indicator associated with the messaging page (e.g., the messaging instance 907 associated with the other user 908, a messaging instance 907 associated with a user who is not a contact, friend, follower, or the like of the user 902, etc.), the social networking system may identify the trigger. In some examples, the trigger may be identified based on one or more interactions, by the user 902, with the messaging page 904, such as scrolling through the messages 906, requesting to view a user profile associated with the other user 908, and/or the like.

In various examples, in response to identifying the trigger, the social networking system may cause a presentation of a notification 916 including the recommendation 918 to review or modify the setting(s) associated with the user account. In at least one example, the recommendation 918 includes a recommendation to review message control settings associated with the user account. For example, in response to identifying a trigger based on user interactions with the messaging page, the social networking system generates the recommendation 918 to review the message control settings. The message control settings may include permissions associated with who can send the user 902 messages, privacy settings associated with messages, viewing details about the messaging instance 907, accepting or deleting the messaging instance 907, blocking the other user 908, and/or the like.

In various examples, the notification 916 may be presented as a pop-up notification, an overlay on the user interface (e.g., half-sheet, three-quarter sheet, etc.), a highlight or headline associated with the user interface, or other means by which social networking system may draw attention to information provided in the notification. In various examples, the notification 916 may be presented for a period of time (e.g., 3 seconds, 5 seconds, 1 minute, etc.). In such examples, the notification 916 may include an ephemeral message to the user 902 providing information associated with the user account.

In various examples, the notification 916 includes a review control 920 that, when selected by the user 902, enables the user 902 to view a message settings page, for reviewing and/or updating permissions associated with messaging instances 907. FIG. 9B illustrates an interface 900b in which a message control page 922 is presented in association with the messaging page 904. As described above, the message control page 922 may include one or more controls 924 associated with managing messaging instances 907 associated with other users. For example, in response to receiving an indication of selection of a control 924 associated with the illustrated message request, the social networking system may provide a means by which the user 902 access data associated with the messaging instance 907 and/or the other user 908.

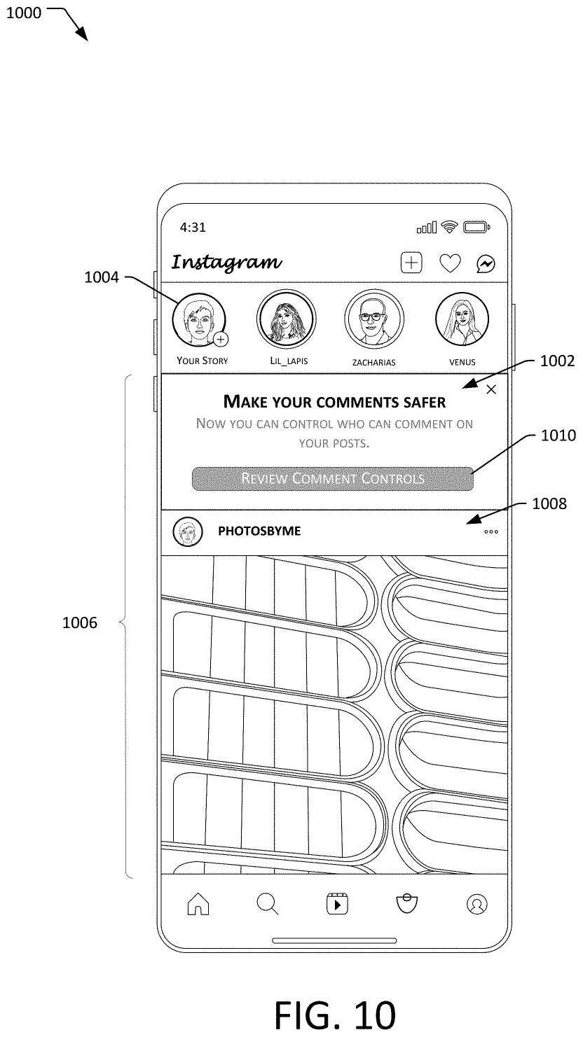

FIG. 10 illustrates an example interface 1000 associated with providing a recommendation 1002 for a user 1004 to review controls settings associated with a user account, as described herein. In the illustrative example, the recommendation 1002 may be presented via a messaging feed 1006 associated the user account. The messaging feed 1006 may include one or more posts 1008 (or messages) posted via the social networking system. The post(s) 1008 may be published (or posted) by the user 1004 and/or by another user with whom the user 1004 has an established connection (e.g., friends, followers, contacts, etc.).

In various examples, the social networking system may cause a presentation of the recommendation 1002 in response to a trigger. The trigger can include a user interaction by the user 1004 and/or another user of the social networking system with the user account. In at least one example, the trigger may be associated with an update to a functionality associated with a user account and/or the social networking system. For example, in response to identifying that a new security control is authorized for use in association with the user account, the social networking system may identify the trigger. For another example, in response to identifying an upgrade to a user account (e.g., from regular account to influencer, from an unpaid account to a paid account, etc.), the social networking system may identify the trigger.

In the illustrative example, the recommendation 1002 includes a recommendation to review comment controls. However, this is not intended to be so limiting and the recommendation 1002 may include a recommendation to review or modify additional or alternative controls, such as mention controls, tag controls, etc. In various examples, the recommendation 1002 may include a review selectable control 1010 that, when selected by the user 1004, may cause a comment settings page, such as comment settings page 212, to be presented via the interface 1000. In other examples, the recommendation 1002 may, itself, be selectable such as to cause the comment settings page to be presented via the interface 1000 (e.g., with or without the review selectable control).

FIG. 11 illustrates a block diagram illustrating an example system 1100 of computing devices usable to implement example techniques described herein. For example, FIG. 1 illustrates example computing devices including one or more social network system servers 1102, a first computing device 1104, and a second computing device 1106, that interact over a network, such as network 108 of FIG. 1. By way of example and not limitation, the social network system server(s) 1102 may be representative of servers used to implement the system 100, the first computing device 1104 may be representative of the first user computing device 104(1) associated with the first user 102(1), and the second computing device 1106 may be representative of the second user computing device 104(2) associated with the second user 102(2).

The social network system server(s) 1102 may comprise one or more individual servers or other computing devices that may be physically located in a single central location or may be distributed at multiple different locations. The social network system server(s) 1102 may be hosted privately by an entity administering all or part of the communications network (e.g., a utility company, a governmental body, distributor, a retailer, manufacturer, etc.), or may be hosted in a cloud environment, or a combination of privately hosted and cloud hosted services.

Each of the computing devices described herein may include one or more processors and/or memory. Specifically, in the illustrated example, social network system server(s) 1102 include one or more processors 1110 and memory 1112, the first computing device 1104 includes one or more processors 1114 and memory 1116, the second computing device 1106 includes one or more processors 1118 and memory 1120. By way of example and not limitation, the processor(s) may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory may comprise one or more non-transitory computer-readable media and may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

As shown in FIG. 11, the social network system server(s) 1102 include a social networking application 1126, the first computing device 1104 includes social network client application 1128, and the second computing device 1106 includes social network client application 1130 that enables interaction of content among the computing devices via the social network system server(s) 1102. For example, content (e.g., text, images, audio, video, GIFs, emojis, and/or the like associated with posts, comments to posts, direct messages, etc.) can be shared among users associated with social networking accounts (e.g., user accounts 1134) of an online social network provided by the social networking system and may include sharing content in accordance with a user account of a user that is restricted. In various examples, data associated with user accounts of users of the social networking system may be stored in association with the social networking application 1126, such as in the user accounts 1134. In some examples, the user accounts 1134 may be personal accounts associated with an individual user or business accounts associated with a business of a user (e.g., merchant accounts). In some examples, the messaging client application enables interfaces to access content, to view content, and to generate content as those described with reference to FIGS. 2A-10, for example. In particular examples, social networking system server(s) 1102 sends instructions to present, transmit, and receive content as discussed with reference to FIGS. 2A-10.

FIG. 11 further illustrates social networking system server(s) 1102 as including settings component 1132, such as settings component 110, to enable functionality with regard to providing recommendations to update settings of a user account 1134 of a particular user based on a trigger, as described herein. The user account 1134 may include settings associated with one or more actions that other users (associated with other user accounts) can take with respect to the user account 1134 of the particular user. For example, the settings may include limitations on other users commenting on data published by the user via the social networking system (e.g., posts published by the user), tagging or mentioning the user in a post, sending a direct message to the user, and/or the like. In at least one example, a setting associated with a first user account of a first user and limiting performance of one or more actions, with respect to the first user account, of a second user associated with a second user account may be stored in association with the first user account and/or the second user account.

In various examples, the settings component 1132 may be configured to identify one or more triggers associated with a user account. As described above, the trigger may be identified based on one or more interactions of a user associated with the user account and/or one or more interactions of other users with the user account. In some examples, the one or more interactions of the other users may include a number and/or frequency of comments associated with a particular post or communication published by the user, a number of connection requests received from the other users over a period of time, a number of connections that are associated with the user account (e.g., a number of other users that are connected to the user account as friends, followers, contacts, etc.), and/or the like.

As shown in FIG. 11, social networking system server(s) 1102 include communications connection(s) 1142, the first computing device 1104 includes communications connection(s) 1144, and the second computing device 1106 includes communications connection(s) 1146 that enables communication between two or more of the social networking system server(s) 1102, the first computing device 1104, and the second computing device(s) 1106, and/or additional computing device(s).

The communication connection(s) 1142, 1144, and/or 1146, can include physical and/or logical interfaces for connecting social networking system server(s) 1102, the first computing device 1104, and/or the second computing device 1106 to another computing device or a network, such as network(s) 108. For example, the communications connection(s) 1142, 1144, and/or 1146 can enable Wi-Fi-based communication such as via frequencies defined by the IEEE 802.11 standards, short range wireless frequencies such as Bluetooth®, cellular communication (e.g., 2G, 2G, 4G, 4G LTE, 5G, etc.) or any suitable wired or wireless communications protocol that enables the respective computing device to interface with the other computing device(s).

While FIG. 11 is provided as an example system 1100 that can be used to implement techniques described herein, the techniques described and claimed are not limited to being performed by the system 1100, nor is the system 1100 limited to performing the techniques described herein.

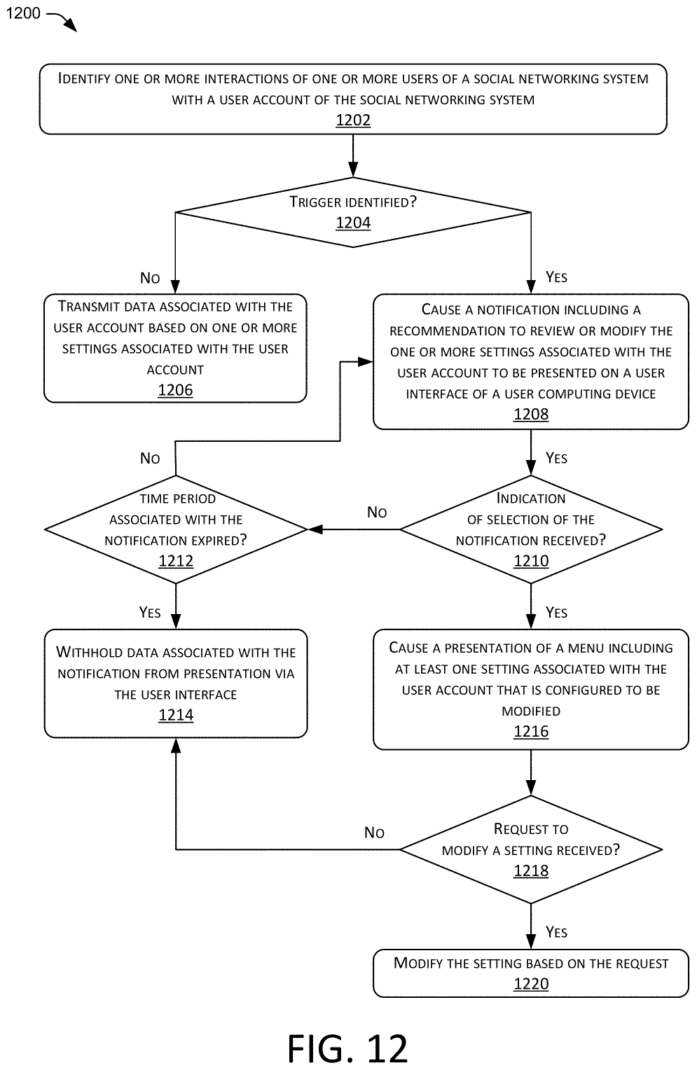

FIG. 12 illustrates an example process in accordance with embodiments of the disclosure. The process is illustrated as logical flow graphs, each operation of which represents a sequence of operations that may be implemented in hardware, software, or a combination thereof. In the context of software, the operations represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular abstract data types.

The order in which the operations are described is not intended to be construed as a limitation, and any number of the described operations may be combined in any order and/or in parallel to implement the processes. In some examples, one or more operations of the above-described methods may be omitted entirely. By way of example and not limitation, operations 1202, 1206, and 1208 may be performed without operations 1206 and 1210-1216. Moreover, the methods described herein can be combined in whole or in part with each other or with other methods.

FIG. 12 illustrates an example process 1200 for providing a recommendation to review or modify one or more settings associated with a user account based on an identified trigger. In some instances, some or all of the process 1200 may be performed by one or more components in systems 100 or 1100. By way of example and not limitation, some or all of the operations in the process 1200 may be performed by the social networking system 106 and/or social network system server(s) 1102. In some examples, some or all of the operations in the process 1200 may be performed by a user computing device, such as computing device(s) 104, computing device 1104, first computing device 104(1), computing device 1106, and/or the second computing device 104(2). However, the process 1200 is not limited to being performed by the system 100 or 1100.

At operation 1202, the social networking system identifies one or more interactions of one or more users of a social networking system with a user account of the social networking system. In various examples, the social networking system may identify first interaction data associated with one or more interactions of the user with the user account and/or second interaction data associated with one or more interactions of other users with the user account. Non-limiting examples of first interaction data include data associated with generating and publishing a post, message, or other communication in association with user account, accessing a settings page associated with the user account, deleting one or more comments associated with a post, blocking another user account from a post and/or from accessing data associated with the user account, providing an indication of intent to delete a comment or perform another action with respect to an interaction by another user with the user account, disabling a commenting functionality with respect to one or more posts, viewing activity corresponding to interactions of other users with the user account (comments, tags, mentions, etc.), viewing a message generated by another user with whom the user is not connected, and/or other interactions of the user with the user account. Similarly, non-limiting examples of the second interaction data may include data associated with transmitting a comment, reaction, emoji, GIF, video, image, or the like in response to a post published (by the user) in association with the user account, transmitting a direct message to the user via the user account, transmitting a request to connect with the user and/or the user account (e.g., become a follower, friend, contact, etc.), tagging or mentioning the user associated with the user account in a post or communication published via the social networking system, and/or other interactions with the user account of the other users.

At operation 1204, the social networking system determines whether a trigger (e.g., triggering action) is identified (e.g., detected). In at least one example, the trigger is associated with a recommendation to modify a setting associated with the user account. In various examples, the trigger may be identified based on at least one of the first interaction data or the second interaction data. That is, the trigger may be associated with interactions by the user and/or other users with the user account. In some examples, the trigger may be associated with a total number and/or frequency of interactions with the user account by one or more other users, a number of connections and/or frequency of receiving connection requests, a total number of comments associated with one or more posts published by the user and/or a frequency associated with the comments, and/or an association of the user with an event (e.g., event determined to have a substantial probability (e.g., more than a threshold) of increasing user interactions with the user account).

Based on a determination that the trigger is not identified (“No” at operation 1204), the social networking system, at operation 1206, transmits data associated with the user account based on one or more settings associated with the user account. The social networking system may cause the data to be presented via one or more user interfaces, such as those described above with regard to FIGS. 2A-10.

Based on a determination that the trigger is identified (“Yes” at operation 1204), the social networking system, at operation 1208, causes a notification including a recommendation to review or modify the one or more settings associated with the user account to be presented on a user interface of a user computing device. As discussed above, the recommendation may include a recommendation to modify one or more settings associated with the user account. In some examples, the recommendation may include a recommendation to review or modify a particular type of setting (e.g., comment controls, tag controls, mention controls, messaging controls, etc.) and/or a particular setting (e.g., recommendation to modify who can comment on posts).

The notification may include a pop-up notification, push notification, chat, or other type of notification. In at least one example, the notification may be presented in association with an instance of a social networking application, associated with the social networking system, and stored on a computing device of the user. In various examples, the notification and/or recommendation may include a selectable control that, when selected by the user, enables the user to review and/or modify one or more settings associated with the user account.

At operation 1210, the social networking system determines whether an indication of selection of the notification is received. The indication of selection may include an activation of a selectable control associated with at least one of the notification or the recommendation.

Based on a determination that the indication of selection of the notification is not received (“No” at operation 1210), the social networking system, at operation 1212, determines whether a time period associated with the notification has expired. The time period associated with the notification may include a period of time (e.g., 2 seconds, 3 seconds, etc.) that the notification is to be presented to the user, prior to removal from the user interface.

Based on a determination that the time period associated with the notification has not expired (“No” at operation 1212), the social networking system causes a notification including the recommendation to review or modify the one or more settings to be presented via the user interface, as described above with respect to at least operation 1208.

Based on a determination that the time period associated with the notification has expired (“Yes” at operation 1212), the social networking system, at operation 1214, withholds data associated with the notification from presentation via the user interface. In various examples, a withholding of data associated with the notification may include a removal of the data from presentation via the user interface.

Based on a determination that the indication of selection of the notification is received (“Yes” at operation 1210), the social networking system, at operation 1216, causes a presentation of a menu including the at least one setting associated with the user account that is configured to be modified. The menu may include one or more setting controls associated with the trigger, the recommendation, and/or the notification. In at least one example, the menu includes a list of control(s) associated with a comment settings page, such as comment settings page 212, comment settings page 424, comment settings page 606, and/or comment settings page 722, a tag or mention control page, such as tag settings page 822, a message control page, such as message control page 922, and/or the like.

At operation 1218, the social networking system determines whether a request to modify a setting of the at least one setting is received. In various examples, a request to modify a setting may include an input associated with a setting control of the setting controls described above, such as with regard to the comment settings pages, tag or mention settings page, message control page, and/or the like. In various examples, the request to modify the setting may include an input associated with a change to a current setting (e.g., previously established setting, default setting, etc.) associated with a time that the user selects the settings control option.

Based on a determination that the request is not received (“No” at operation 1218), the social networking system withholds data associated with the notification from presentation via the user interface, as described above with regard to at least operation 1214.

Based on a determination that the request is received (“Yes” at operation 1218), the social networking system, at operation 1220, modifies the setting based on the request. In various examples, the social networking system stores data associated with the updated setting in association with the user account and/or one or more user accounts associated with one or more other users. In at least one example, the social networking system applies the updated setting to subsequent user interactions with the user account.

### CONCLUSION

Although the discussion above sets forth example implementations of the described techniques, other architectures may be used to implement the described functionality, and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
identifying one or more interactions of one or more users of a social networking system with a user account of the social networking system;
identifying, based at least in part on the one or more interactions, a trigger associated with a recommendation to review or modify a setting associated with the user account, wherein the setting relates to an ability of other user accounts to interact with the user account; and
in response to identifying the trigger, causing a notification to be presented on a user interface of a user computing device associated with the user account, the notification comprising the recommendation to review or modify the setting associated with the user account.

2. The method of claim 1, further comprising:
receiving, from the user computing device via the user interface, a first indication of selection of a selectable control associated with the notification;
in response to receiving the first indication of selection, causing a presentation, in association with the user interface, of a menu including one or more settings associated with the user account that are configured to be modified via the menu;
receiving, from the user computing device and in association with the menu, a request to modify at least one setting of the one or more settings; and
updating the at least one setting based at least in part on the request, wherein updating the at least one setting comprises disabling or enabling a permission of another user to interact with the user account.

3. The method of claim 1, further comprising:
determining at least one of a number of interactions or a frequency of interactions with the user account over a period of time,
wherein the trigger comprises a determination that the at least one of the number of interactions or the frequency of interactions meets or exceeds a threshold value.

4. The method of claim 1, further comprising:
determining, based at least in part on a context of an interaction of the one or more interactions, that a user associated with the user account is associated with an event;
determining that a probability of increased interactions with the user account from a plurality of users of the social networking system based on a participation of the user in the event exceeds a threshold probability; and
determining that a current time is within a threshold period of time of a time associated with the event,
wherein identifying the trigger comprises identifying that the event in which the probability of increased interactions meets or exceeds a threshold is within the threshold period of time of the current time, and
wherein the notification comprises a first recommendation to modify the setting associated with the user account to a more restrictive setting.

5. The method of claim 4, wherein the trigger is a first trigger occurring at a first time, the method further comprising:
identifying an end time associated with the event;
determining, at a second time after the first time, that a second threshold period of time has passed since the end time, the second threshold period of time being associated with a cool down period after the event;
identifying a second trigger associated with the recommendation to review or modify the setting associated with the user account; and
in response to identifying the second trigger, causing a second notification to be presented in association with the user account, the second notification comprising a second recommendation to modify the setting to a less restrictive setting.

6. The method of claim 1, further comprising:
identifying that a first interaction of the one or more interactions by a user associated with the user account comprises an indication of selection of a comment, by a second user associated with a second user account, and presented in association with a post generated by the user and published via the social networking system, a selection of the comment being associated with viewing one or more actions associated with the comment;
causing a presentation, on the user interface of the user computing device, of one or more indicators associated with the one or more actions; and
receiving an indication of selection of a cancel selectable control associated with not performing an action of the one or more actions,
wherein the trigger comprises a determination that the user did not perform the action associated with the comment.

7. The method of claim 1, further comprising:
identifying that a first interaction of the one or more interactions by a user associated with the user account comprises a request to delete a comment published by a second user associated with a second user account and presented in association with a post generated by the user and presented via the user interface; and
in response to the request to delete the comment, withholding data associated with the comment from presentation via the user interface,
wherein the trigger comprises a determination that the user deleted the comment associated with the post, and
wherein the recommendation comprises a recommended action to review comment settings associated with at least one of the post or the user account.

8. The method of claim 1, wherein the setting comprises at least one of:
a comment control;
a tag control;
a messaging control; or
a mention control.

9. A social networking system comprising:
one or more processors; and
one or more computer-readable media storing instructions that, when executed by the one or more processors, cause the social networking system to perform operations comprising:
identifying one or more interactions of one or more users of a social networking system with a user account of the social networking system;
identifying, based at least in part on the one or more interactions, a trigger associated with a recommendation to review or modify a setting associated with the user account, wherein the setting relates to an ability of other user accounts to interact with the user account; and
in response to identifying the trigger, causing a notification to be presented on a user interface of a user computing device associated with the user account, the notification comprising the recommendation to review or modify the setting associated with the user account.

10. The social networking system of claim 9, wherein identifying the trigger comprises determining that a value associated with a characteristic of the user account meets or exceeds a threshold value.

11. The social networking system of claim 10, wherein the characteristic comprises at least one of:
a number of other user accounts that are associated with the user account;
a frequency of interactions of the other user accounts that are associated with the user account; or
a number of comments received from the other user accounts in association with a communication published in association with the user account.

12. The social networking system of claim 9, wherein identifying the trigger comprises:
identifying a communication published by a first user corresponding to the user account; and
identifying an interaction of the one or more interactions associated with the user in association with a comment published by a second user in response to the communication, wherein the interaction comprises at least one of:
a request to delete the comment; or
an indication of intent to perform an action associated with the comment, the action comprising at least one of submitting a report associated with the comment, deleting the comment, restricting comments from the second user in association with the communication, or blocking the second user from accessing the user account.

13. The social networking system of claim 9, wherein the operations further comprise:
receiving, from the user computing device via the user interface, a first indication of selection of a selectable control associated with the notification;
in response to receiving the first indication of selection, causing a presentation, in association with the user interface, of a menu associated with one or more settings associated with the user account that are configured to be modified via the menu;
receiving, from the user computing device and in association with the menu, a request to modify at least one setting of the one or more settings; and
updating the at least one setting based at least in part on the request.

14. The social networking system of claim 12, wherein updating the at least one setting comprises disabling or enabling a permission of another user to interact with the user account.

15. The social networking system of claim 9, wherein identifying the trigger comprises:
determining that a user associated with the user account is associated with an event; and
determining that a probability of increased interactions by a plurality of users with the user account, based on a participation of the user in the event, exceeds a threshold probability,
wherein the notification comprises a first recommendation to modify the setting associated with the user account to a more restrictive setting.

16. One or more non-transitory computer-readable media storing instructions that, when executed by one or more processors of a social networking system, cause the one or more processors to perform operations comprising:
identifying one or more interactions of one or more users of a social networking system with a user account of the social networking system;
identifying, based at least in part on the one or more interactions, a trigger associated with a recommendation to review or modify a setting associated with the user account, wherein the setting relates to an ability of other user accounts to interact with the user account; and
in response to identifying the trigger, causing a notification to be presented on a user interface of a user computing device associated with the user account, the notification comprising the recommendation to review or modify the setting associated with the user account.

17. The one or more non-transitory computer-readable media of claim 16, the operations further comprising:
receiving, from the user computing device via the user interface, a first indication of selection of a selectable control associated with the notification;
in response to receiving the first indication of selection, causing a presentation, in association with the user interface, of a menu associated with one or more settings associated with the user account that are configured to be modified via the menu;
receiving, from the user computing device and in association with the menu, a request to modify at least one setting of the one or more settings; and
updating the at least one setting based at least in part on the request, wherein updating the at least one setting comprises disabling or enabling an ability of another user to interact with the user account.

18. The one or more non-transitory computer-readable media of claim 16, wherein identifying the trigger comprises determining that a value associated with a characteristic of the user account meets or exceeds a threshold value, the characteristic comprising at least one of:
a number of other user accounts that are associated with the user account;
a frequency of interactions of the other user accounts that are associated with the user account; or
a number of comments received from the other user accounts in association with a communication published in association with the user account.

19. The one or more non-transitory computer-readable media of claim 16, wherein the setting comprises at least one of:
a comment control;
a tag control;
a messaging control; or
a mention control.

20. The one or more non-transitory computer-readable media of claim 16, wherein the trigger is identified utilizing machine learning techniques.
